(19) United States
(12) Patent Application Publication
(10) Pub. No.: US 2018/0017714 A1
(43) Pub. Date: Jan. 18, 2018

(54) OPTICAL FILM LAMINATE, OPTICAL DISPLAY DEVICE USING THE SAME, AND TRANSPARENT PROTECTIVE FILM

(71) Applicant: NITTO DENKO CORPORATION, Ibaraki-shi ,Osaka (JP)

(72) Inventors: Hirofumi NOMOTO, Ibaraki-shi (JP); Nobuyuki HAITA, Ibaraki-shi (JP); Takeharu KITAGAWA, Ibaraki-shi (JP)

(73) Assignee: NITTO DENKO CORPORATION

(21) Appl. No.: 15/516,439

(22) PCT Filed: Oct. 2, 2015
(86) PCT No.: PCT/JP2015/078056

§ 371 Date: Apr. 3, 2017

(30) Foreign Application Priority Data
Oct. 2, 2014 (JP) 2014-204027

(51) Int. Cl. B32B 27/08; G02B 5/30; B32B 7/02; B32B 27/30

(52) U.S. Cl. CPC G02B 1/14; B32B 27/08; B32B 27/306; G02B 5/3033; B32B 7/02; B32B 2307/42; B32B 2307/584; B32B 2307/412

(57) ABSTRACT

The optical film laminate comprises: a polarizing film which is formed of a polyvinyl alcohol-based resin containing a molecularly-oriented dichroic martial, and has a thickness of 10 μm or less; and a transparent protective film formed of a thermoplastic resin and disposed on one of opposite surfaces of the polarizing film through an adhesive layer. The transparent protective film has a thickness of 40 μm or less, and a dimensional change rate in a direction orthogonal to an absorption axis of the polarizing film is 0.2% or more, as measured using a test piece thereof having a size of 100 mm×100 mm, in a state after leaving the test piece in an environment at 85° C. for 48 hours.

### TECHNICAL FIELD

The present invention relates to an optical film laminate comprising a polarizing film and a transparent protective film; an optical display device using the optical film laminate; and a transparent protective film.

### BACKGROUND ART

A thinned polarizing film is being developed for use in an optical display device for a television, a mobile phone, a personal digital assistant or other electronic units. For example, according to a technique disclosed in JP 4815544 B (Patent Document 1), it is possible to produce even a thinned polarizing film having a thickness, e.g., of 10 μm or less.

Generally, a polyvinyl alcohol-based resin (hereinafter referred to as “PVA-based resin”) formed into a film shape is used as a material for polarizing films including the polarizing film disclosed in the Patent Document 1. The PVA-based resin has a hydrophilic property and a high moisture absorption property, and has a disadvantage of being easily influenced by changes in temperature and humidity and being easily elongated and contracted to undergo a dimensional change, according to surrounding environmental changes. It is known that a stress arising from such a dimensional change of a polarizing film causes deformation such as warpage (curl), in a member such as a display panel positioned adjacent to the polarizing film, leading to deterioration in display quality.

Generally, in a polarizing film for televisions, with a view to suppressing a dimensional change of a polarizing film, etc., a TAC (triacetylcellulose-based) film having a thickness of 40 to 80 μm is laminated to each of opposite surfaces of the polarizing film to serve as a transparent protective film. Theretofore, a thinned polarizing film having a thickness, e.g., of 10 μm or less has been considered to be relatively less likely to exert the negative effect on a member such as a display panel adjacent thereto, by reason of a function of the transparent protective film laminated to the polarizing film and that, when the thickness is as small as 10 μm or less, a stress arising from a dimensional change of the polarizing film becomes significantly smaller as compared to a relatively-thick polarizing film.

### CITATION LIST

### Patent Document

Patent Document 1: JP 4815544 B
Patent Document 2: JP 2009-161744 A
Patent Document 3: JP 2010-072135 A

### SUMMARY OF INVENTION

### Technical Problem

However, along with progress of product development, a new problem with a thinned polarizing film has emerged. Specifically, it has become evident that, although a thinned polarizing film is definitely less likely to exert the negative effect on a member such as a display panel adjacent thereto, a stress arising from a dimensional change of the thinned polarizing film is directly applied to the thinned polarizing film, thereby causing a new problem that a crack is formed in the thinned polarizing film itself. Further, along with reduction in thickness of a functional film, there has been proposed a layered configuration in which a transparent protective film is provided to protectively cover only one surface (one side) of the polarizing film, instead of both surfaces (both sides) as in a conventional polarizing film. However, when such a one-side protected structure is applied to a thinned polarizing film, it has a great influence on the thinned polarizing film, so that the above problem becomes more prominent. A crack formed in a polarizing film, even a small crack, can cause the occurrence of uneven display in a liquid crystal display device. Thus, for reducing the occurrence of uneven display, it is necessary to give consideration to design, for example, to carefully select a material for each member for use in an optical film laminate.

The present invention has been made to solve the above problems in the conventional techniques, and an object thereof is to provide an optical film laminate capable of reducing a stress which is possibly generated in an interface between a polarizing film and a transparent protective film due to a dimensional change of the polarizing film, by appropriately selecting a material for the transparent protective film while taking into account the dimensional change of the polarizing film, without adding modification to the polarizing film itself, and further provide an optical display device using the optical film laminate, and a transparent protective film.

### Solution to Technical Problem

(1) Through diligent researches on the above problems, the present inventors have found that the following optical film laminate can reduce a stress which is possibly generated in an interface between a polarizing film and a transparent protective film due to the dimensional change of the polarizing film, and have finally achieved the present invention. Specifically, according to a first aspect of the present invention, there is provided an optical film laminate comprising: a polarizing film which is formed of a polyvinyl alcohol-based resin containing a molecularly-oriented dichroic martial, and has a thickness of 10 μm or less; and a transparent protective film formed of a thermoplastic resin and disposed on one of opposite surfaces of the polarizing film through an adhesive layer, wherein the transparent protective film has a thickness of 40 μm or less, and a dimensional change rate in a direction orthogonal to an absorption axis of the polarizing film is 0.2% or more, as measured using a test piece thereof having a size of 100 mm×100 mm, in a state after leaving the test piece in an environment at 85° C. for 48 hours.
(2) In the optical film laminate mentioned in the section (1), a ratio of the dimensional change rate of the transparent protective film to a dimensional change rate of the polarizing film, in the direction orthogonal to the absorption axis of the polarizing film, may be from 0.05 to 1. According to this feature, it becomes possible to effectively reduce the stress possibly generated in the interface between the polarizing film and the transparent protective film due to the dimensional change of the polarizing film.
(3) In the optical film laminate mentioned in the section (1) or (2), an easy-adhesion layer may be provided between the adhesive layer and the polarizing film.
(4) In the optical film laminate mentioned in any one of the sections (1) to (3), the transparent protective film may be one selected from the group consisting of an acrylic-based resin film, a polyethylene terephthalate-based resin layer, and a polyolefin-based resin film.
(5) In the optical film laminate mentioned in any one of the sections (1) to (4), the transparent protective film may be an acrylic-based resin film which is stretched in a direction orthogonal to the absorption axis of the polarizing film, at a temperature equal to or greater than Tg, where Tg denotes a glass transition temperature of the acrylic-based resin film.
(6) In the optical film laminate mentioned in the sections (5), the transparent protective film may be formed using an acrylic-based resin film which has a glutarimide ring or a lactone ring in a main chain thereof.
(7) An optical display device using the optical film laminate mentioned in any one of the sections (1) to (6), can be provided.
(8) According to a second aspect of the present invention, there is provided a transparent protective film formed of a thermoplastic resin, wherein the transparent protective film has a thickness of 40 μm or less, and a dimensional change rate in a direction orthogonal to an absorption axis of a polarizing film is 0.2% or more, as measured using a test piece thereof having a size of 100 mm×100 mm, in a state after leaving the test piece in an environment at 85° C. for 48 hours. This transparent protective film is significantly effectively usable together with a polarizing film having a thickness of 10 m or less, to manufacture an optical film laminate.
(9) The transparent protective film mentioned in the section (8) may be disposed, through an adhesive layer, on one of opposite surfaces of a polarizing film which is formed of a polyvinyl alcohol-based resin containing a molecularly-oriented dichroic martial, and has a thickness of 10 μm or less.
(10) The transparent protective film mentioned in the section (8) or (9) may be one selected from the group consisting of an acrylic-based resin film, a polyethylene terephthalate-based resin layer, and a polyolefin-based resin film.
(11) The transparent protective film mentioned in any one of the sections (8) to (10) may be an acrylic-based resin film stretched in a direction orthogonal to the absorption axis of the polarizing film, at a temperature equal to or greater than a glass transition temperature of the acrylic-based resin film.
(12) The transparent protective film mentioned in the section (11) may be formed using an acrylic-based resin film having a glutarimide ring or a lactone ring in a main chain thereof.

### Effect of Invention

The present invention can provide an optical film laminate capable of reducing a stress which is possibly generated in an interface between a polarizing film and a transparent protective film due to a dimensional change of the polarizing film, by appropriately selecting a material for the transparent protective film while taking into account the dimensional change of the polarizing film, and can further provide an optical display device using the optical film laminate, and a transparent protective film.

### BRIEF DESCRIPTION OF DRAWINGS

FIG. 1 is a diagram depicting one example of a production method for a polarizing film.

FIG. 2 is a graph depicting a relationship between TD stretching ratio and dimensional change rate of a transparent protective film.

FIG. 3 is a graph depicting a relationship between the TD stretching temperature and the dimensional change rate of the transparent protective film.

FIG. 4 is a diagram depicting a shape of a cut-out sample of an optical film laminate according to the present invention, for crack evaluation.

FIG. 5a is a sectional view depicting an optical display device according to one of various embodiments of the present invention, using an optical film laminate according to the present invention.

FIG. 5b is a sectional view depicting an optical display device according to another embodiment of the present invention, using an optical film laminate according to the present invention.

FIG. 5c is a sectional view depicting an optical display device according to yet another embodiment of the present invention, using an optical film laminate according to the present invention.

FIG. 5d is a sectional view depicting an optical display device according to still another embodiment of the present invention, using an optical film laminate according to the present invention.

FIG. 5e is a sectional view depicting an optical display device according to yet still another embodiment of the present invention, using an optical film laminate according to the present invention.

FIG. 5f is a sectional view depicting an optical display device according to another further embodiment of the present invention, using an optical film laminate according to the present invention.

FIG. 6a is a sectional view depicting an optical display device according to yet a further embodiment of the present invention.

FIG. 6b is a sectional view depicting an optical display device according to still a further embodiment of the present invention.

FIG. 6c is a sectional view depicting an optical display device according to an additional embodiment of the present invention.

FIG. 6d is a sectional view depicting an optical display device according to yet an additional embodiment of the present invention.

FIG. 6e is a sectional view depicting an optical display device according to other embodiment of the present invention.

### DESCRIPTION OF EMBODIMENTS

One preferred embodiment of the present invention will now be described.

A stress which appears in an interface between a polarizing film and a transparent protective film is considered to be caused by a difference between respective dimensional change rates (in a contraction direction) of the polarizing film and the transparent protective film during heating and cooling. Based on this knowledge, for each of a plurality of polarizing films having various thicknesses, the present inventors first measured respective dimensional change rates thereof caused by heating and cooling. This measurement was carried out using TMA manufactured by Seiko Instruments Inc. It should be noted that, although a measuring method for the dimensional change rate of a polarizing film is different from a measuring method described in the aftermentioned Sub-Section “4-(3) Dimensional Change Rate of Protective Film”, the two measuring methods are substantially compatible with each other. The measuring method for the dimensional change rate of a polarizing film was used just as an alternative method, because it is difficult to measure the dimensional change rate of a polarizing film by the measuring method described in the aftermentioned Sub-Section “4-(3) Dimensional Change Rate of Protective Film”.

Specifically, first of all, a 5 μm-thick polarizing film was cut into a strip-shaped sample having a length of 4 mm in a direction of an absorption axis thereof (hereinafter referred to as “MD direction”) and a length of 25 mm in a direction orthogonal to the absorption axis (hereinafter referred to as “TD direction”). Then, the sample was set on chucks with an inter-chuck distance of 20 mm, and stretched in the TD direction under a condition that a tensile load was controlled so as to be maintained at 19.6 mg, and an ambient temperature was raised from 25° C. to 85° C. at a temperature rising speed of 10° C./min and held at 85° C. for 10 minutes. Subsequently, the ambient temperature was lowered at a temperature falling speed of 10° C./min. After repeating this operation for 48 hours, the dimensional change rate of the sample was measured by TMA. As a result, the dimensional change rate (in the contraction direction) reached about 3.0%. In this regard, a larger value of this dimensional change rate means a larger amount of contraction.

Although this dimensional change rate is about a 5 μm-thick polarizing film produced by a method described in the aftermentioned Section “2. Production of Polarizing Film”, the TD directional dimensional change rate of a polarizing film having a different thickness, such as a 12 μm-thick polarizing film described in the aftermentioned Comparative Examples 1 and 4, was also measured by the same method. As a result, for the 12 μm-thick polarizing film, a value of 4.0% was obtained. The 12 m-thick polarizing film was obtained by a heretofore-known production method as disclosed, for example, in JP 4913787 B, i.e., a method in which a single layer of PVA is directly subjected to dyeing and stretching. Although the dimensional change rate of a polarizing film is evidently considered to be determined by not only a thickness thereof but also another factor, e.g., a stretching condition such as a stretching ratio, the thickness of the polarizing film would be regarded as a factor exerting the largest influence on the dimensional change rate. This is because, when the film thickness of the polarizing film becomes larger, i.e., when, assuming that a plane extending in a direction perpendicular to a thickness direction of the polarizing film is defined as a neutral plane, a distance from the neutral plane to a bonding interface between the polarizing film and a transparent protective film becomes larger, a stress in the bonding interface is increased in proportion to the distance between the neutral plane and the bonding interface, and a crack is considered to be formed when the stress goes beyond a breaking stress of the polarizing film. Thus, for example, the 12 μm-thick polarizing film has a larger dimensional change rate than that of the 5 μm-thick polarizing film, and is more likely to undergo crack formation, accordingly. However, a result of experiments showed that a polarizing film having a thickness of 10 μm or less has a TD directional dimensional change rate of 3.0% or less, as with the 5 μm-thick polarizing film, although there is a slight difference depending on a production method therefor and others, i.e., it is less contracted than the 12 μm-thick polarizing film.

On the other hand, the result of experiments also showed that a conventional protective film, i.e., a 40 to 80 μm-thick TAC (triacetylcellulose-based) film, has a dimensional change rate of about 0.01 to 0.5%, i.e., there is a difference of about 10 times between respective dimensional change rates of the conventional protective film and a polarizing film, as measured by the same method.

Evidently, for reducing a stress which is possibly generated in an interface between a polarizing film and a protective film, it is necessary to set the dimensional change rates of the two films to values close to each other (in other words, to set a ratio therebetween to a value close to “1”). However, current techniques have difficulty in controlling the dimensional change rate of a thinned polarizing film whose thickness is reduced to 10 μm or less. Therefore, the present invention focused on the dimensional change rate of a protective film disposed on one surface of a polarizer through an adhesive layer, without changing the dimensional change rate of the polarizing film. Specifically, the dimensional change rate of the protective film was studied from mainly two viewpoints to derive an optimal value of the dimensional change rate of the protective film for a thinned polarizing film. One of the viewpoints is the presence or absence of a crack after subjecting an optical film laminate to a given heat cycle, and the other viewpoint is the number of the heat cycles taking place just before formation of a crack having a given depth in the optical film laminate. Details of this study will be described below.

### 1. Production of Protective Film

One example of a production method for a protective film usable in an optical film laminate according to the present invention. It should be understood that this production method is shown merely by way of example, and any other suitable production method may be employed. As mentioned above, a condition required for the protective film is to have a dimensional change rate permitting the dimensional change rate of the optical film, and any other condition does not matter here.

For example, the protective film may be produced by a melt extrusion process, i.e., a process comprising: melting a thermoplastic resin such as polycarbonate at high temperatures to obtain a melt; extruding the melt from a lip of a T-die; and winding the extruded melt by a cooling roll.

A material for the protective film is not particularly limited, and examples of the material may include an acrylic-based resin, a polyethylene terephthalate-based resin such as polyethylene terephthalate (PET), and a cycloolefin-based resin such as cycloolefin-based polymer (COP) used as a material for optical films. Examples of PET include a non-crystallizable PET substrate described in the aftermentioned Sub-Section “2-[Laminate Preparation Step (A)]”. Examples of COP include various commercially-available products such as “trade name: ZEONOR manufactured by Zeon Corporation”, “trade name: ZEONEX manufactured by Zeon Corporation”, “trade name: Arton manufactured by JSR Corporation”, “trade name: Topas manufactured by Topas Advanced Polymers GmbH” and “trade name: APEL manufactured by Mitsui Chemicals, Inc.”.

Further, as for the acrylic-based resin, in this application, primarily with a view to improve thermal resistance, a ring structure such as a lactone ring or a glutarimide ring is incorporated in a main chain of the acrylic-based resin. However, this ring structure may be optionally incorporated, but may be omitted. For example, such an acrylic-based resin having a glutarimide ring or a lactone ring in the main chain thereof is produced in the following manner.

### (1) Production of Protective Film Using (Meth)Acrylic Resin Having Glutarimide Ring Unit

This process is based on a process disclosed in the Patent Document 2. First of all, an imidized resin was produced using a methyl methacrylate-styrene copolymer (styrene content: 11 mol %) as a raw material resin, and monomethylamine as an imidization agent.

An extruder used was an inter-meshing co-rotating twin-screw extruder having a bore (caliber) of 15 mm. A preset temperature of each temperature control zone of the extruder was set in the range of 230 to 250° C., and a screw rotational speed of the extruder was set to 150 rpm. Methyl methacrylate-styrene copolymer (hereinafter referred to also as “MS resin”) was supplied to the extruder at a feed rate of 2 kg/hr, and melted by a kneading block to fill a kneading zone with the molten resin, and then 16 weight parts of monomethylamine (manufactured by Mitsubishi Gas Chemical Company, Inc.) was injected from a nozzle with respect to 100 weight parts of the molten resin. A reverse flight was provided at a terminal end of a reaction zone to enable the reaction zone to be filled with the molten resin. A pressure at a vent port was reduced to −0.092 MPa to remove a reaction by-product and excess methylamine. The molten resin extruded as a strand from a die provided at an outlet of the extruder was cooled in a water tank and then pelletized by a pelletizer to obtain an imidized MS resin (1).

Subsequently, in the inter-meshing co-rotating twin-screw extruder having a bore of 15 mm, the preset temperature of each temperature control zone thereof was set to 230° C., and the screw rotational speed was set to 150 rpm. The imidized MS resin (1) obtained from a hopper was supplied to the extruder at a feed rate of 1 kg/hr, and melted by the kneading block to fill the kneading zone with the molten resin, and then a mixed solution of 0.8 weight part of dimethyl carbonate and 0.2 weight part of triethylamine was injected from the nozzle with respect to 100 weight parts of the molten resin to reduce a carboxyl group in the molten resin. A reverse flight was provided at the terminal end of the reaction zone to enable the reaction zone to be filled with the molten resin. The pressure at the vent port was reduced to −0.092 MPa to remove a reaction by-product and excess dimethyl carbonate. The molten resin extruded as a strand from the die provided at the outlet of the extruder was cooled in the water tank and then pelletized by the pelletizer to obtain an imidized MS resin (2) having a reduced acid value.

Subsequently, the imidized MS resin (2) was input into the inter-meshing co-rotating twin-screw extruder having a bore of 15 mm, under the following conditions: the preset temperature of each temperature control zone of the extruder was set to 230° C.; the screw rotational speed of the extruder was set to 150 rpm: and the feed rate of the imidized MS resin (2) was set to 1 kg/hr. The pressure at the vent port was reduced to −0.095 MPa to re-remove volatile matters such as unreached auxiliary materials. The devolatilized imide resin (imide resin after removal of volatile matters) extruded as a strand from the die provided at the outlet of the extruder was cooled in the water tank and then pelletized by the pelletizer to obtain an imidized MS resin (3).

The imidized MS resin (3) is equivalent to a glutarimide resin obtained by copolymerization of a glutarimide unit represented by the general formula (1), a (meth)acrylate ester unit represented by the general formula (2) and an aromatic vinyl unit represented by the general formula (3), which are described in the embodiment of the Patent Document 2.

For the imidized MS resin (3), an imidization rate, a glass transition temperature, an acid value and a Sp value were measured in accordance with the method described in the Patent Document 2. As a result, the imidization rate was 70 mol %, the glass transition temperature was 143° C., the acid value was 0.2 mmol/g, and the SP value was 9.38.

A mixture of 100 weight % of the imidized MS resin (3) obtained in the above manner and 1.0 weight % of SEESORB 151 (ultraviolet absorbing agent manufactured by Shipro Kasei Kaisha Ltd., 1% weight reduction temperature: 341° C., Sp value: 11.33) was pelletized using a single-screw extruder.

Subsequently, pellets of the (meth)acrylic resin having a glutarimide ring unit were dried at 100.5 kPa and 100° C. for 12 hours, and extruded from a T-die of a single-screw extruder at a die temperature of 270° C., so that it was formed into a film shape. Then, the resulting film was stretched at a stretching ratio of 2 times in its conveyance direction (MD direction) in an atmosphere having a temperature greater than the glass transition temperature (Tg) of the resin by 10° C., and then stretched at a stretching ratio of 2 times in a direction (TD direction) orthogonal to the film-conveyance direction in an atmosphere having a temperature greater than the Tg of the resin by 7° C. to obtain a 40 μm-thick biaxially-stretched film, i.e., a protective film. As is well known, the Tg of a (meth)acrylic resin having a glutarimide ring unit is 126° C.

(2) Production of Protective Film using (Meth)acrylic Resin having Lactone Ring Unit

This process is based on a process disclosed in the Patent Document 3. 40 parts of methyl methacrylate, 10 parts of methyl 2-(hydroxymethyl)acrylate, 50 parts of toluene and 0.025 parts of ADEKASTAB 2112 (manufactured by ADEKA Corporation) were fed into a 1000-L reaction pot equipped with a stirring device, a temperature sensor, a cooling device and a nitrogen introduction pipe, and the resulting mixture was refluxed while being heated to 105° C. with penetration of nitrogen. Then, 0.05 parts of t-amylperoxyisononanoate (manufactured by Atofina Yoshitomi, Ltd., trade name: LUPASOL 570) was added thereto as a polymerization initiator, and simultaneously the solution was polymerized under reflux (about 105 to 110° C.), while 0.10 parts of t-amylperoxyisononanoate was dripped thereinto over 2 hours. Then, the solution was subjected to aging for 4 hours.

0.05 parts of stearyl phosphate (manufactured by Sakai Chemical Industry Co., Ltd., Phoslex A-18) was added to the above polymerized solution, and a cyclization condensation reaction was progressed for 2 hours, under reflux (about 90 to 110° C.).

Subsequently, a polymer solution obtained through the cyclization condensation reaction was passed through a multi-tubular heat exchanger heated to 240° C. to complete the cyclization condensation reaction. Then, the resulting polymer was introduced, at a processing speed of 20 kg/hour in terms of a resin content, into a vent-type twin-screw extruder ((p=44 mm, L/D=52.5) which had a barrel temperature of 240° C., a screw rotational speed of 120 rpm, a pressure reduction degree of 13.3 to 400 hPa, one rear vent, four fore vents (hereinafter referred to as first, second, third, and fourth vents, respectively, in order from the side of an upstream end of the extruder), and a side feeder between the third and fourth vents, so that it was devolatilized. During this process, a mixed solution of an antioxidant and a deactivation agent, which had been preliminarily prepared separately, was injected thereinto at an input rate of 0.3 kg/hour from a position just downstream of the second vent by using a high-pressure pump. Further, ion-exchanged water was injected thereinto at an input rate of 0.33 kg/hour from each of two positions just downstream of the first vent and the side feeder by using a high-pressure pump.

Furthermore, an AS resin (trade name: Stylac AS783L manufactured by Asahi Kasei Chemicals Corporation) was added thereto at a feed rate of 2.12 kg/hour from the side feeder.

Subsequently, the melted-kneaded resin was filtered through a leaf disk-type polymer filter (manufactured by Nagase & Co., Ltd., filtration accuracy: 5 m).

The mixed solution of an antioxidant and a deactivation agent was prepared by dissolving 50 parts of ADEKASTAB AO-60 (manufactured by ADEKA Corporation) and 40 parts of zinc octylate (manufactured by Nihon Kagaku Sangyo Co., Ltd., NIKKA OCTHIX zinc: 3.6%) in 210 parts of toluene.

Through the above devolatilizing, pellets of a thermoplastic acrylic resin composition (A-I) were obtained. A resin part thereof has a weight-average molecular weight of 132,000, and a glass transition temperature (Tg) of 125° C.

Subsequently, in the same manner as that for the (meth)acrylic-based resin having a glutarimide ring unit, pellets of the (meth)acrylic-based resin having a lactone ring unit were dried at 100.5 kPa and 100° C. for 12 hours, and extruded from a T-die of a single-screw extruder at a die temperature of 270° C., so that it was formed into a film shape. Then, the resulting film was stretched at a stretching ratio of 2 times in its conveyance direction (MD direction) in an atmosphere having a temperature greater than the glass transition temperature (Tg) of the resin by 10° C., and then stretched at a stretching ratio of 2.65 times in a direction (TD direction) orthogonal to the film-conveyance direction in an atmosphere having a temperature greater than the Tg of the resin by 12° C. to obtain a 20 μm-thick biaxially-stretched film, i.e., a protective film. As is well known, the Tg of a (meth)acrylic resin having a lactone ring unit is 127° C.

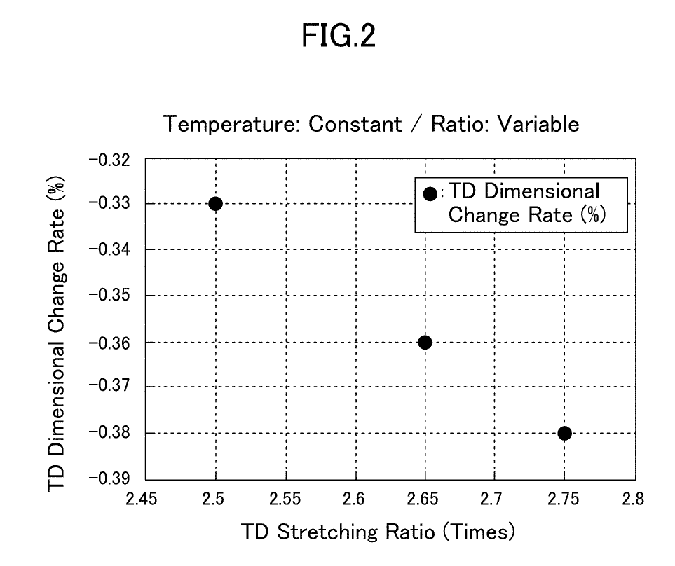

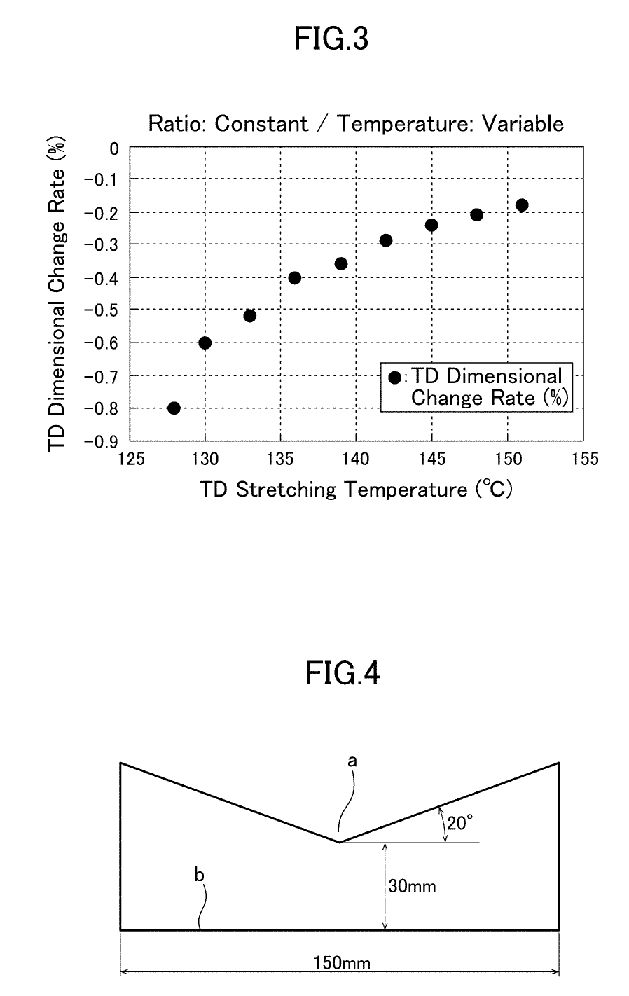

(3) FIG. 2 is a graph depicting a relationship between TD stretching ratio and dimensional change rate of a transparent protective film obtained in the above Sub-Section “1-(2) Production of Protective Film using (Meth)acrylic Resin having Lactone Ring Unit” when the stretching temperature is maintained constant (Tg+12° C.), and FIG. 3 is a graph depicting a relationship between the TD stretching ratio and the dimensional change rate of a transparent protective film obtained in the above Sub-Section 1-(2) when the stretching ratio is maintained constant (the stretching ratio in the MD direction is set to 2 times, and the stretching ratio in the TD direction is set to 2.65 times).

As is evident from FIG. 2, the TD stretching ratio and the dimensional change rate are in an approximately proportional relation. Although not depicted in the graph, the same relation may be considered to be also applicable to a region where the stretching ratio is around 2.0 times (used in the aftermentioned Example 1).

Further, as is evident from FIG. 3, the dimensional change rate becomes smaller along with an increase in the TD stretching temperature, and has a minimum value at a time when the TD stretching temperature reaches a given temperature, whereafter it will never go lower than that. Thus, by setting the TD stretching temperature to a given temperature, e.g., a temperature equal to or greater than the Tg, under a given stretching rate, it becomes possible to maintain the dimensional change rate at 0.2% or more.

In principle, as a temperature becomes higher, molecular orientation becomes more isotropic due to thermal motion of polymer molecules, so that a molecular orientation degree is considered to be kept at a relatively low even if the stretching ratio is increased. The dimensional change rate is considered to be largely dependent on the molecular orientation degree of a finally-produced film. Specifically, when the film has a relatively high molecular orientation degree, it is urged to become isotropic during reheating, so that the dimensional change rate (in the contraction direction) of the film becomes large. On the other hand, when the film has a relatively low molecular orientation degree, it is not so largely contracted during reheating. As a result, for example, as depicted in FIG. 2, in the case where the TD stretched temperature is maintained constant, and the TD stretching ratio is changed, the dimensional change rate becomes larger along with an increase in the TD stretching ratio. On the other hand, as depicted in FIG. 3, in the case where the TD stretching ratio is maintained constant, and the TD stretched temperature is changed, the dimensional change rate becomes larger along with a decrease in the TD stretching temperature.

### 2. Production of Polarizing Film

Next, one example of a production method for a polarizing film usable in an optical film laminate according to the present invention will be described together with general material properties of a thermoplastic resin for use in producing the polarizing film. It should be understood that this production method is shown merely by way of example, and any other suitable production method may be employed.

Thermoplastic resins are roughly classified into two types: one which is in a state in which polymer molecules are orderly arranged; and the other which is in a state in which polymer molecules are not orderly arranged as a whole, or only a small part of polymer molecules are orderly arranged. The former state is called “crystallized state”, and the latter state is called “amorphous or non-crystallized state”. Correspondingly, one type of thermoplastic resin having a property capable of being transformed from a non-crystallized state into a crystallized state depending on conditions is called “crystallizable resin”, and the other type of thermoplastic resin which does not have such a property is called “non-crystallizable resin”. On the other hand, regardless of whether a crystallizable resin or a non-crystallizable resin, a resin which is not in a crystallized state or has not been transformed into a crystallized state, is called “amorphous or non-crystalline resin”. The term “amorphous or non-crystalline” will be used herein in distinction from the term “non-crystallizable” which means a property incapable of transformation into a crystallized state.

For example, the crystallizable resin may include olefin type resins such as polyethylene (PE) and polypropylene (PP), and ester type resins such as polyethylene terephthalate (PET) and polybutylene terephthalate (PBT). One feature of the crystallizable resin is that, based on heating and/or stretching/orienting, polymer molecules are orderly arranged, and crystallization is progressed. Physical properties of the resin vary according to a degree of crystallization. On the other hand, even in the crystallizable resin, such as polypropylene (PP) or polyethylene terephthalate (PET), it is possible to suppress crystallization by inhibiting polymer molecules from being orderly arranged through heating or stretching/orienting. The crystallization-inhibited polypropylene (PP) and polyethylene terephthalate (PET) will hereinafter be referred to respectively as “non-crystallizable polypropylene” and “non-crystallizable polyethylene terephthalate”, and referred to respectively and generically as “non-crystallizable olefin type resin” and “non-crystallizable ester type resin”.

For example, in case of polypropylene (PP), it is possible to produce a crystallization-inhibited non-crystallizable polypropylene (PP) by forming it into an atactic structure having no stereoscopic regularity. Further, for example, in case of polyethylene terephthalate (PET), it is possible to produce a crystallization-inhibited non-crystallizable polyethylene terephthalate (PET) by copolymerizing isophthalic acid or a modifier group such as 1,4-cyclohexanedimethanol, as a polymerizing monomer, i.e., by copolymerizing a molecule which inhibits crystallization of polyethylene terephthalate (PET).

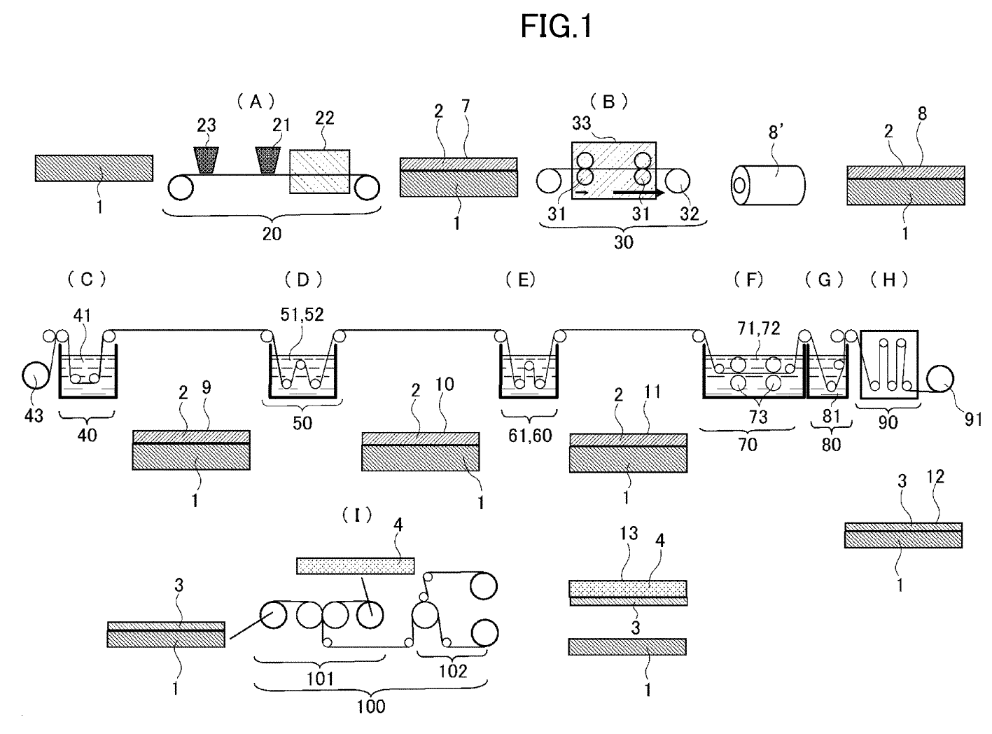

FIG. 1 is a schematic diagram depicting a production process capable of producing a polarizing film having a thickness of 10 μm or less, e.g., 5 μm or less.

### [Laminate Production Step (A)]

As a thermoplastic resin substrate serving as a substrate on which a polarizing film is formed in a coating manner, a 200 μm-thick substrate (trade name: NOVACLEAR SHO46 manufactured by Mitsubishi Chemical Corporation, thickness: 200 m) of a continuous web of isophthalic acid-copolymerized polyethylene terephthalate obtained by copolymerizing 6 mol % of isophthalic acid with polyethylene terephthalate (hereinafter referred to as “non-crystallizable PET”) was used. This thermoplastic resin has a non-crystallizable property, i.e., is less likely to be crystallized and deteriorated in terms of stretching ratio, even by applying heat thereto. The substrate of the continuous web of the polyethylene terephthalate has a glass transition temperature of 75° C. On the other hand, a PVA layer has a glass transition temperature of 80° C.

An aqueous PVA solution was prepared by dissolving, in water, a PVA powder having a polymerization degree of 4200 and a saponification degree of 99.2% and containing 1 weight % of acetoacetyl-modified PVA having a polymerization degree of 1200, a saponification degree of 99.0% and an acetoacetyl modification degree of 4.6% (trade name: GOHSEFIMER Z200 manufactured by Nippon Synthetic Chemical Industry Co., Ltd), to have a concentration of 4 to 5 wt %. Then, in a laminate forming apparatus 20 comprising a coating device 21, a drying device 22 and a surface modifying device 23, the aqueous PVA solution was applied to the non-crystallizable PET substrate 1 so as to have a film thickness of 12 μm after drying, and subjected to hot-air drying in an atmosphere at 60° C., to produce a laminate having a PVA-based resin layer formed on the substrate. The laminate obtained in the above manner will hereinafter be referred to as a “laminate comprising a non-crystallizable PET substrate and a PVA layer formed on the substrate”, or a “PVA layer-including laminate”, or a “laminate 7”.

The laminate 7 comprising the PVA layer 2 will be finally produced as a 5 μm-thick polarizing film 3 through the following process comprising a 2-stage stretching step consisting of preliminary in-air stretching and in-boric-acid-solution stretching. However, a polarizing film having an arbitrary thickness of 10 μm or less, such as a 6 μm-thick, 4 μm-thick or 3 μm-thick polarizing film, or 10 μm-thick or 12 μm-thick polarizing film, can be formed by appropriately changing a thickness of a PVA-based resin layer to be formed on the non-crystallizable PET substrate 1 or the aftermentioned stretching ratio.

[Preliminary in-Air Stretching Step (B)]

In a preliminary in-air stretching step (B) as a first-stage stretching, the laminate 7 comprising the 12 μm-thick PVA layer 2 was stretched integrally with the non-crystallizable PET substrate 1 to form a “stretched laminate 8” comprising the PVA layer 2. Specifically, in a preliminary in-air stretching apparatus 30 having stretching device 31 provided within an oven 33, the laminate 7 comprising the PVA layer 2 was fed to pass through the stretching device 31 within the oven 33 set to a stretching temperature environment at 120° C. which is greater than the glass transition temperatures of the PVA layer and the substrate, so that it was subjected to free-end uniaxial stretching to attain a stretching ratio of 2.0 times to thereby form an 8 μm-thick stretched laminate 8. At this stage, the stretched laminate 8 may be wound on a take-up unit 32 provided in side-by-side relation to the oven 33, to produce a roll 8′ of the stretched laminate 8. In this embodiment, the stretching ratio in the auxiliary in-air stretching was set to 2.0 times. Alternatively, depending on an intended thickness and polarization degree, the stretching ratio in this step may be increased up to 3.5 times.

Now, free-end stretching and fixed-end stretching will be generally described. When a long film is stretched in a conveyance direction thereof, the film is contracted in a direction perpendicular to the direction of the stretching, i.e. in a width direction of the film. The free-end stretching means a technique of performing stretching without suppressing such contraction. Longitudinal uniaxial stretching is a technique of performing stretching only in a longitudinal direction of the film. The free-end uniaxial stretching is generally used in contrast with the fixed-end uniaxial stretching which is a technique of performing stretching while suppressing the contraction which would otherwise occur in a direction perpendicular to the stretching direction. Through the free-end uniaxial stretching, the 12 μm-thick PVA layer 2 comprised in the laminate 7 is formed into an 8 μm-thick PVA layer 2 in which PVA molecules are oriented in the stretching direction.

### [First Insolubilization Step (C)]

In a first insolubilization step (C), the stretched laminate 8 unrolled from a feeding unit 43 loaded with the roll 8′ was subjected to insolubilization to form an insolubilized stretched laminate 9. It should be understood that the stretched laminate 9 insolubilized in this step comprises an insolubilized PVA layer 2. This laminate 9 will hereinafter be referred to as an “insolubilized stretched laminate 9”.

Specifically, in an insolubilization apparatus 40 containing a first insolubilizing aqueous boric acid solution 41, the stretched laminate 8 was immersed in the first insolubilizing aqueous boric acid solution 41 at a solution temperature of 30° C., for 30 seconds. The first insolubilizing aqueous boric acid solution 41 used in this step contains 3 weight parts of boric acid with respect to 100 weight parts of water (hereinafter referred to as “insolubilizing aqueous boric acid solution”). This step is intended to subject the stretched laminate 8 to insolubilization so as to prevent the PVA layer comprised in the stretched laminate 8 from being dissolved at least during the subsequent dyeing step (D).

### [Dyeing Step (D)]

Then, in a dyeing step (D), a dyed laminate 10 was formed in which iodine as a dichroic material is adsorbed to the 8 μm-thick PVA layer 2 having the oriented PVA molecules. Specifically, in a dyeing apparatus 50 equipped with a dyeing bath 52 of a dyeing solution 51, the insolubilized stretched laminate 9 fed from the first insolubilization apparatus 40 was immersed in the dyeing solution 51 at a solution temperature of 30° C., to form a dyed laminate 10 which is a laminate obtained by adsorbing iodine to the molecularly-oriented PVA layer 2 of the insolubilized stretched laminate 9.

In this step, in order to prevent dissolution of the PVA layer 2 comprised in the stretched laminate 8, an iodine concentration and a potassium iodide concentration in the dyeing solution 51 were adjusted to fall within the range of 0.08 to 0.25 weight % and the range of 0.56 to 1.75 weight %, respectively, and a ratio of the iodine concentration to the potassium iodide concentration was set to 1:7. In this step, the iodine concentration, the potassium iodide concentration and a time period of the immersion (immersion time) are considered to exert a significant influencer on a concentration of the iodine element to be contained in the PVA layer. Thus, by adjusting the iodine concentration, the potassium iodide concentration and the immersion time in this step, it becomes possible to adjust a single transmittance of a finally-produced polarizing film. For example, in this embodiment, by adjusting respective concentrations of iodine and potassium iodide to fall within the above ranges of the iodine concentration and the potassium iodide concentration, and adjusting the immersion time, it becomes possible to adsorb iodine to the molecularly-oriented PVA layer 2 of the stretched laminate so as to enable the PVA layer comprised in a finally-produced polarizing film 3 to have a single transmittance of 45.0%. It should be understood that the intended single transmittance is not limited to 45.0%, but may be 44.0%, 44.4%, 44.5%, or 45.5%.

### [Second Insolubilization Step (E)]

A second insolubilization step (E) described below is performed for the following purposes. This step is intended to achieve (i) insolubilization for preventing dissolution of the PVA layer 2 comprised in the dyed laminate 10 during the subsequent in-boric-acid-solution stretching step (F), (ii) stabilization in dyeing for preventing elution of iodine adsorbed to the PVA layer 2; and (iii) formation of nodes by cross-linking of molecules in the PVA layer 2. The second insolubilization step is intended to realize particularly the purposes (i) and (ii).

The second insolubilization step (E) is performed as a pretreatment for the in-boric-acid-solution stretching step (F). The dyed laminate 10 formed in the dyeing step (D) was subjected to insolubilization to form an insolubilized dyed laminate 11. This laminate will hereinafter be referred to as “insolubilized dyed laminate 11”. The insolubilized dyed laminate 11 comprises an insolubilized PVA layer 2. Specifically, in a second insolubilization apparatus 60 containing an aqueous solution 61 comprising iodine and potassium iodide (hereinafter referred to as “second aqueous boric acid solution”), the dyed laminate 10 was immersed in the second aqueous boric acid solution 61 at 40° C., for 60 seconds, so as to cross-link the PVA molecules of the PVA layer having the iodine adsorbed thereto, to form an insolubilized dyed laminate 11. The second insolubilized aqueous boric acid solution used in this step contains 3 weight parts of boric acid with respect to 100 weight parts of water, and 3 weight parts of potassium iodide with respect to 100 weight parts of water.

### [In-Boric-Acid-Solution Stretching Step (F)]

In an in-boric-acid-solution stretching step as a second-stage stretching, the insolubilized dyed laminate 11 comprising the PVA layer 2 having molecularly-oriented iodine was further stretched to form a laminate 12 which comprises the PVA layer having molecularly-oriented iodine and making up a 5 μm-thick polarizing film 3. Specifically, in an in-boric-acid-solution stretching apparatus 70 equipped with stretching device 73 and a bath 72 of an aqueous boric acid solution 71 containing boric acid and potassium iodide, the insolubilized dyed laminate 11 continuously fed from the second insolubilization apparatus 60 was immersed in the aqueous boric acid solution 71 set to a stretching temperature environment at a solution temperature of 70° C., and then fed to pass through the stretching device 73 provided in the in-boric-acid-solution stretching apparatus 70, so that it was subjected to free-end uniaxial stretching to attain a stretching ratio of 2.7 times to thereby form the laminate 12. Although a total stretching ratio in this embodiment is 5.5 times, it may be set in the range of 5.0 to 6.5 times by adjusting respective stretching ratios in the preliminary in-air stretching step and the in-boric-acid-solution stretching step.

More specifically, the aqueous boric acid solution 71 was adjusted to contain 6.5 weight parts of boric acid with respect to 100 weight parts of water, and 5 weight parts of potassium iodide with respect to 100 weight parts of water. A polarizing film according to the present invention is high in transmittance and small in number of cross-linking nodes through which polyiodide ions are adsorbed to the PVA, so that, in this step and the subsequent cleaning step, a polyiodide ion and an iodine ion are more likely to be eluted. Therefore, a concentration of boric acid in the aqueous boric acid solution in this step is set to a higher value than ever before to thereby reduce an elution amount of polyiodide ions adsorbed to the PVA (and iodine ions and potassium ions) and thus achieve stabilization in dyeing.

In this step, the insolubilized dyed laminate 11 having iodine adsorbed thereto in an adjusted amount was first immersed in the aqueous boric acid solution 71 for 5 to 10 seconds. Then, the insolubilized dyed laminate 11 was fed to directly pass through between a plurality of sets of rolls having different circumferential speeds, which serve as the stretching device 73 of the in-boric-acid-solution stretching apparatus 70, so that it was subjected to free-end uniaxial stretching to attain a stretching ratio of 2.7 times by taking a time of 30 to 90 seconds. Through this stretching, the PVA layer comprised in the cross-linked dyed laminate 11 was changed into a 5 μm-thick PVA layer in which the absorbed iodine is highly oriented in one direction in the form of a PVA-iodine complex comprising PVA and polyiodide ions (I₃⁻ and I₅⁻) adsorbed to the PVA. This PVA layer makes up a polarizing film 3 of the laminate 12.

### [Cleaning Step (G))

The insolubilized dyed laminate 11 was subjected to stretching in the in-boric-acid-solution stretching step (F), and then taken out of the aqueous boric acid solution 71. The taken-out laminate 12 comprising the polarizing film 3 was fed to a cleaning step (G). The cleaning step (G) is intended to wash out unnecessary residuals adhered on a surface of the thinned high-performance polarizing film 3. Specifically, the laminate 12 was fed to a cleaning apparatus 80 and immersed in a cleaning solution 81 containing potassium iodide having a solution temperature of 30° C., for 1 to 10 seconds, so as to prevent dissolution of the PVA of the thinned high-performance polarizing film 3. A concentration of potassium iodide in the cleaning solution 81 was 4 weight parts with respect to 100 weight parts of water.

### [Drying Step (H)]

The cleaned laminate 12 was fed to a drying step (H) and dried therein. Then, the dried laminate 12 was wound on a take-up apparatus 91 provided in side-by-side relation to a drying apparatus 90, as a continuous web of the laminate 12, to form a roll of the laminate 12 comprising the thinned high-performance polarizing film 3. Any appropriate process, such as natural drying, blow drying and thermal drying, may be employed as the drying step (H). In this embodiment, the drying was performed by warm air at 60° C., for 240 seconds in an oven type drying apparatus 90.

Through the above process, a 5 μm-thick polarizing film is produced.

### 3. Production of Optical Film Laminate

An optical film laminate according to the present invention comprises a combination of the protective film obtained in the Section “1. Production of Protective Film” and the polarizing film obtained in the Section “2. Production of Polarizing Film”. For example, through a step (I), i.e., [Lamination/Transfer Step (I)], in FIG. 1, an optical film laminate can be produced. In this case, the polarizing film 3 which is formed on a thermoplastic substrate, e.g., the non-crystallizable PET substrate 1 is subjected to lamination with respect to a protective film 4 (which may include any other optical film), and the resulting laminate is taken up. In this take-up step, an optical film laminate 13 is formed by transferring the polarizing film 3 to the protective film 4 while peeling off the non-crystallizable PET substrate 1 therefrom. Specifically, the laminate 12 was unrolled from the roll by an unrolling/laminating unit 101 comprised in a laminating/transferring apparatus 100, and the polarizing film 3 of the unrolled laminate 12 was transferred to the protective film 4 by a take-up/transfer unit 102 comprised in a laminating/transferring apparatus 100, so as to form the optical film laminate 13. In the course of this operation, the polarizing film 3 was peeled off from the substrate 1. Although not particularly depicted, an adhesive layer is provided between the polarizing film 3 and the protective film 4. This adhesive layer is formed of a light-curable adhesive prepared by mixing 40 weight parts of N-hydroxyethylacrylamide (HEAA), 60 weight parts of acryloylmorpholine (ACMO), and 3 weight parts of a photoinitiator “IRGACURE 819” (manufactured by BASF). The prepared adhesive was applied onto the polarizing film 3 so as to have a thickness of 0.5 μm after curing, and one surface of the polarizing film 3 having the adhesive applied thereon was laminated to an easy-adhesion layer on the protective film 14. Then, the adhesive was irradiated with UV rays as active energy rays and cured. UV light irradiation was performed using a gallium-doped metal halide lamp and an irradiation apparatus (Light HAMMER 10 manufactured by Fusion UV Systems, Inc., bulb: V bulb, peak illuminance: 1,600 mW/cm², cumulative dose: 1,000/m² (wavelength: 380 to 440 nm)), and illuminance of the UV light was measured using a Sola-Check System manufactured by Solatell.

Further, instead of using a protective film provided separately from the non-crystallizable PET substrate 1 as mentioned in the Sub-Section “2-[Laminate Production Step (A)], the non-crystallizable PET substrate 1 may be utilized as a protective film. For example, after peeling off the non-crystallizable PET substrate 1 from the polarizing film 3 once, the non-crystallizable PET substrate 1 may be laminated to the polarizing film 3 to serve as a protective film. Alternatively, a laminate of the polarizing film 3 and the non-crystallizable PET substrate 1 may be stretched to have a desired thickness, without being peeled off from each other, to form an optical film laminate 13

### 4. Evaluation Method for Optical Film Laminate

For a protective film, a polarizing film and an optical film laminate, the following evaluations were performed.

### (1) Measurement of Thickness of Protective Film

A thickness of a protective film produced in the above manner was measured in a state before being laminated to a polarizing film, at five points along a width direction thereof by using a dial gauge (manufactured by OZAKI MFG Co., Ltd.).

### (2) Measurement of Thickness of Polarizing Film

A polarizing film produced in the above manner was sampled in a state before being laminated to a protective film, i.e., when the laminate 12 was unrolled from the roll by the unrolling/laminating unit 101. Then, after peeling off the polarizing film from the thermoplastic substrate, a thickness of the polarizing film was measured using the dial gauge described in the Sub-Section 4-(1).

### (3) Dimensional Change Rate of Protective Film

For a protective film before being laminated to a polarizing film, i.e., the protective film 4 unrolled by the unrolling/laminating unit 101 in FIG. 1, so as to allow the polarizing film 3 to be transferred thereto, a measurement of dimensional change rate was performed in the following manner.

The produced protective film was cut into a test sample having a square shape with 100 mm length in a conveyance direction thereof (MD direction) and 100 mm width in a direction perpendicular to the conveyance direction (TD direction), and a reference point was set at a position adjacent to a midpoint of each of four sides of the test sample. Then, in a room temperature environment at 25° C. and 50% RH, a distance “a” between the reference points of opposed two of the sides was measured. Subsequently, the test sample was put in a drying oven (manufacturing by Espec Corporation) at 85° C. as an environment tester, for 48 hours, and then extracted from the 85° C. environment tester, and placed in the same room temperature environment at 25° C. and 50% RH as that before the measurement. Then, after 30 minutes, a distance “a′” between the reference points of the opposed sides was measured in the same manner using a planar biaxial dimension measuring device (QV606 manufactured by Mitutoyo Corporation). In this case, a dimensional change rate in the MD direction was respectively calculated by the following formula: (a′−a)/a×100(%).

### (4) Crack Evaluation for Optical Film Laminate

For an optical film laminate obtained in the above manner, the following crack evaluation was performed.

(4-1) Evaluation on Presence or Absence of Crack after Applying Heat Cycles

An optical film laminate produced in the above manner was cut into a test sample having a rectangular shape with 200 mm length in the MD direction and 150 mm width in the TD direction, and the test sample was attached to a central area of an alkali-free glass plate having a length of 250 mm, a width of 170 mm and a thickness 1 mm, through a pressure-sensitive adhesive. Subsequently, the test sample was subjected to pressure defoaming treatment using a pressure defoaming apparatus (manufactured by Kurihara Seisakusho Co., Ltd.), under a pressure of 0.5 MPa at 50° C. for 15 minutes. Then, the test sample attached to the glass was put in an environment tester to apply 100 cycles of cold and hot shocks ranging from −40° C. to 85° C. thereto, and it was checked whether a crack is formed in the MD direction.

### (4-2) Evaluation on Number of Heat Cycles Taking Place Just Before Formation of Crack Having Given Depth

The produced optical film laminate was cut into a test sample having a shape depicted in FIG. 4, with a long side in the TD direction, when viewed in a lamination direction perpendicular to the drawing sheet. That is, the polarizing film and the protective film were laminated in a direction perpendicular to the drawing sheet. The cutting was performed using a laser processing machine. Then, the test sample was attached to a central area of an alkali-free glass plate having a length of 250 mm, a width of 170 mm and a thickness 1 mm, through a pressure-sensitive adhesive, and subjected to pressure defoaming treatment using a pressure defoaming apparatus (manufactured by Kurihara Seisakusho Co., Ltd.), under a pressure of 0.5 MPa at 50° C. for 15 minutes. Then, the test sample attached to the glass was put in an environment tester to apply 10 cycles of cold and hot shocks ranging from −40° C. to 85° C. thereto, and a comparison in length of a crack formed in a region around the point “a” in FIG. 4 was performed. The cold and hot shock cycle was applied 100 times at a maximum, and the number of the cycles taking place before the crack reaches the side “b” was counted.

### 5. Ratio of Dimensional Change Rate of Protective Film to Dimensional Change Rate of Polarizing Film

From a view point of reducing a stress which is possibly generated in an interface between the polarizing film and the protective film, a ratio (εf/εp) of a dimensional change rate (εf) of the protective film to a dimensional change rate (εp) of the polarizing film was derived. Evidently, a smaller difference between the two dimensional change rates is preferable. That is, a value of the ratio closer to 1 is preferable. The following Table 1 presents a ratio of the dimensional change rate of a protective film to the dimensional change rate of a polarizing film, wherein the protective film and the polarizing film were actually used in the aftermentioned experiments.

### Example 1

A 40 μm-thick protective film was obtained by the method described in the Sub-Section “1-(1) Production of Protective Film using (Meth)acrylic Resin having Glutarimide Ring Unit”. Further, a 5 μm-thick polarizing film was obtained by the method described in the Section “2. Production of Polarizing Film”. An optical film laminate comprising the protective film and the polarizing film was subjected to the above evaluations.

As a result, the dimensional change rate (in the TD direction) of the protective film was +0.21. Thus, no crack formation occurred, and the number of heat cycles taking place before a crack reaches a given depth was 70. That is, a good result was obtained. Further, the ratio of the dimensional change rate of the protective film to the dimensional change rate of the 5 μm-thick polarizing film was 0.07.

### Example 2

A 20 μm-thick protective film was obtained basically in the same manner as that in Example 1, except that a TD directional stretching ratio during production of the protective film was increased by 30%, i.e., to 2.65 times. This protective film was bonded to the 5 μm-thick polarizing film obtained by the method described in the Section “2. Production of Polarizing Film”, and the resulting optical film laminate was subjected to the above evaluations.

In this Example, the dimensional change rate of the protective film was +0.42. Thus, no crack formation occurred, and a crack did not reach the given depth even after repeating the heat cycle 100 times or more. That is, a better result than that in Example 1 was obtained. Further, the ratio of the dimensional change rate of the protective film to the dimensional change rate of the 5 μm-thick polarizing film was 0.14.

### Example 3

A 20 μm-thick protective film was obtained in the same manner as that in Example 2, except that a TD directional stretching temperature during production of the protective film was increased by 3° C. as compared to Example 1.

In this Example, the dimensional change rate of the protective film was +0.3. Thus, no crack formation occurred, and the number of heat cycles taking place before a crack reaches the given depth was 90. Further, the ratio of the dimensional change rate of the protective film to the dimensional change rate of the 5 μm-thick polarizing film was 0.1.

### Example 4

A 20 μm-thick protective film was obtained in the same manner as that in Example 2, except that the TD directional stretching temperature during production of the protective film was increased by 6° C. as compared to Example 1.

In this Example, the dimensional change rate of the protective film was +0.22. Thus, no crack formation occurred, and the number of heat cycles taking place before a crack reaches the given depth was 70. Further, the ratio of the dimensional change rate of the protective film to the dimensional change rate of the 5 μm-thick polarizing film was 0.073.

### Example 5

A 40 μm-thick protective film was obtained basically in the same manner as that in Example 1, except that the TD directional stretching ratio during production of the protective film was increased by 30%, and an MD directional stretching ratio was adjusted accordingly. Further, a 5 μm-thick polarizing film was obtained by the method described in the Section “2. Production of Polarizing Film”. An optical film laminate comprising the protective film and the polarizing film was subjected to the above evaluations.

In this Example, the dimensional change rate of the protective film was +0.53. Thus, no crack formation occurred, and the number of heat cycles taking place before a crack reaches a given depth was 80. That is, a better result than that in Example 1 was obtained. Further, the ratio of the dimensional change rate of the protective film to the dimensional change rate of the 5 μm-thick polarizing film was 0.177.

### Example 6

A 20 μm-thick protective film was obtained by the method described in the Sub-Section “1-(2) Production of Protective Film using (Meth)acrylic Resin having Lactone Ring Unit”. In this Example, the TD directional streching temperature (139° C.) and the TD directional streching ratio (2.65 times) were the same as those in Example 4. Further, a 5 μm-thick polarizing film was obtained by the method described in the Section “2. Production of Polarizing Film”. An optical film laminate comprising the protective film and the polarizing film was subjected to the above evaluations.

As a result, the dimensional change rate (in the TD direction) of the protective film was +0.36. Thus, no crack formation occurred, and the number of heat cycles taking place before a crack reaches a given depth was 70. That is, a good result was obtained. Further, the ratio of the dimensional change rate of the protective film to the dimensional change rate of the 5 μm-thick polarizing film was 0.12.

### Example 7

After peeling off the non-crystallizable PET substrate described in the Sub-Section “2-[Laminate Production Step (A)], from the polarizing film, the polarizing film was stretched to have a thickness of 20 μm. In this Example, the TD directional streching temperature was set to 100° C., and the TD directional streching ratio was set to 2.0 times.

In this Example, the dimensional change rate of the protective film was −1.78, and the number of heat cycles taking place before a crack reaches the given depth was 80. That is, a good result was obtained. Further, the ratio of the dimensional change rate of the protective film to the dimensional change rate of the 5 μm-thick polarizing film was 0.59. As to the presence or absence of a crack, an experiment was not particularly performed, because a result is obviously anticipated from the number of heat cycles taking place before a crack reaches the given depth and the results of Examples 1 to 6 and others, i.e., it is apparent that no crack formation occurs (this will also be applied to Example 8).

### Example 8

A ZEONOR film (thickness: 50 m) manufactured by Zeon Corporation was used and stretched at a TD directional stretching temperature of 130° C. to attain a TD directional stretching ratio of 2.0 times.

In this Example, the dimensional change rate of the protective film was −0.24, and the number of heat cycles taking place before a crack reaches the given depth was 70. That is, a good result was obtained. Further, the ratio of the dimensional change rate of the protective film to the dimensional change rate of the 5 μm-thick polarizing film was 0.08.

### Comparative Example 1

Comparative Example 1 is basically the same as Example 6, except that the thickness of the polarizing film is set to 12 μm. This 12 μm-thick polarizing film was obtained by a method in which a single layer of PVA is directly subjected to dyeing and stretching, as mentioned above.

In this Comparative Example, although the dimensional change rate of the protective film was +0.36, i.e., a good result was obtained in this respect, the number of heat cycles taking place before a crack reaches the given depth was 10, which shows that the optical film laminate is not enough for practical use. Further, the ratio of the dimensional change rate of the protective film to the dimensional change rate of the 12 μm-thick polarizing film was 0.09. As to the presence or absence of a crack, an experiment was not particularly performed, because a result is obviously anticipated from the number of heat cycles taking place before a crack reaches the given depth and the results of Comparative Examples 2 and 3 and others, i.e., it is apparent that a crack formation occurs (this will also be applied to Comparative Examples 4 to 6).

### Comparative Example 2

Comparative Example 2 is the same as Example 6, except that the TD directional stretching temperature during production of the protective film was increased by 12° C. as compared to Example 6.

In this Comparative Example, the dimensional change rate of the protective film was +0.18. Thus, a crack formation occurred, and the number of heat cycles taking place before a crack reaches the given depth was deleteriously reduced to 10. Further, the ratio of the dimensional change rate of the protective film to the dimensional change rate of the 5 μm-thick polarizing film was 0.06.

### Comparative Example 3

Comparative Example 3 is the same as Example 5, except that the TD directional stretching temperature during production of the protective film was increased by 12° C. as compared to Example 5, and the TD directional stretching ratio was set to 2.05 times.

In this Comparative Example, the dimensional change rate of the protective film was +0.1. Thus, a crack formation occurred, and the number of heat cycles taking place before a crack reaches the given depth was deleteriously reduced to 30. Further, the ratio of the dimensional change rate of the protective film to the dimensional change rate of the 5 μm-thick polarizing film was 0.033.

### Comparative Example 4

Comparative Example 4 is the same as Example 6, except that the TD directional stretching temperature during production of the protective film was increased by 11° C. as compared to Example 6, and the thickness of the polarizing film was set to 12 am. The 12 μm-thick polarizing film was obtained by the same method as that in Comparative Example. In this Comparative Example, the dimensional change rate of the protective film was +0.18. Thus, a crack formation occurred, and the number of heat cycles taking place before a crack reaches the given depth was deleteriously reduced to 10. Further, the ratio of the dimensional change rate of the protective film to the dimensional change rate of the 5 μm-thick polarizing film was 0.06.

### Comparative Example 5

Comparative Example 5 is the same as Example 7, except that the TD directional stretching ratio during production of the protective film was set to 1.0 time.

In this Comparative Example, the dimensional change rate of the protective film was +0.88, i.e., the protective film was excessively expanded. Thus, the number of heat cycles taking place before a crack reaches the given depth was deleteriously reduced to 10. Further, although the ratio of the dimensional change rate of the protective film to the dimensional change rate of the 5 μm-thick polarizing film was 0.29, there is no meaning because of expansion.

### Comparative Example 6

Comparative Example 6 is the same as Example 8, except that the TD directional stretching temperature during production of the protective film was set to 140° C.

In this Comparative Example, the dimensional change rate of the protective film was −0.12. Thus, the number of heat cycles taking place before a crack reaches the given depth was deleteriously reduced to 10. Further, the ratio of the dimensional change rate of the protective film to the dimensional change rate of the 5 μm-thick polarizing film was 0.04.

Test results in Examples 1 to 8 and Comparative Examples 1 to 6 are presented in Table 1.

TABLE 1

| | | | | | | | | Ratio of | | |
|---|---|---|---|---|---|---|---|---|---|---|
| | | | | | | | | Dimensional | | |
| | | Thick- | Thick- | | | Dimensional | Dimensional | Change Rate of | | |
| | | ness of | ness of | TD | TD | Change | Change | Protective Film | | Number |
| | Material of | Protective | Polarizing | Stretching | Stretching | Rate (%) of | Rate (%) of | to Dimensional | Presence | of Heat |
| | Protective | Film | Film | Temperature | Ratio | Protective | Polarizing | Change Rate of | or Absence | Cycles |
| | Film | (μm) | (μm) | (° C.) | (Times) | Film | Film | Polarizing Film | of Crack | (cycles) |
| Exam- | Glutarimide | 40 | 5 | Tg + 7 | 2.0 | +0.21 | 3.0 | 0.07 | Absence | 70 |
| ple 1 | ring-containing | | | | | | | | | |
| | acrylic-based | | | | | | | | | |
| | resin film | | | | | | | | | |
| Exam- | Glutarimide | 20 | 5 | Tg + 7 | 2.65 | +0.42 | 3.0 | 0.14 | Absence | >100 |
| ple 2 | ring-containing | | | | | | | | | |
| | acrylic-based | | | | | | | | | |
| | resin film | | | | | | | | | |
| Exam- | Glutarimide | 20 | 5 | Tg + 10 | 2.65 | +0.3 | 3.0 | 0.1 | Absence | 90 |
| ple 3 | ring-containing | | | | | | | | | |
| | acrylic-based | | | | | | | | | |
| | resin film | | | | | | | | | |
| Exam- | Glutarimide | 20 | 5 | Tg + 13 | 2.65 | +0.22 | 3.0 | 0.073 | Absence | 70 |
| ple 4 | ring-containing | | | | | | | | | |
| | acrylic-based | | | | | | | | | |
| | resin film | | | | | | | | | |
| Exam- | Glutarimide | 40 | 5 | Tg + 7 | 2.6 | +0.53 | 3.0 | 0.177 | Absence | 80 |
| ple 5 | ring-containing | | | | | | | | | |
| | acrylic-based | | | | | | | | | |
| | resin film | | | | | | | | | |
| Exam- | Lactone | 20 | 5 | Tg + 13 | 2.65 | +0.36 | 3.0 | 0.12 | Absence | 70 |
| ple 6 | ring-containing | | | | | | | | | |
| | acrylic-based | | | | | | | | | |
| | resin film | | | | | | | | | |
| Exam- | Polyethylene | 20 | 5 | Tg + 25 | 2.0 | −1.78 | 3.0 | 0.59 | — | 80 |
| ple 7 | terephthalate- | | | | | | | | | |
| | based resin | | | | | | | | | |
| Exam- | Polyolefin- | 25 | 5 | Tg + 30 | 2.0 | −0.24 | 3.0 | 0.08 | — | 70 |
| ple 8 | based resin | | | | | | | | | |
| Compar- | Lactone | 20 | 12 | Tg + 13 | 2.65 | +0.36 | 4.0 | 0.09 | — | <10 |
| ative | ring-containing | | | | | | | | | |
| Exam- | acrylic-based | | | | | | | | | |
| ple 1 | resin film | | | | | | | | | |
| Compar- | Lactone | 20 | 5 | Tg + 25 | 2.65 | +0.18 | 3.0 | 0.06 | Presence | <10 |
| ative | ring-containing | | | | | | | | | |
| Exam- | acrylic-based | | | | | | | | | |
| ple 2 | resin film | | | | | | | | | |
| Compar- | Glutarimide | 40 | 5 | Tg + 19 | 2.05 | +0.1 | 3.0 | 0.033 | Presence | 30 |
| ative | ring-containing | | | | | | | | | |
| Exam- | acrylic-based | | | | | | | | | |
| ple 3 | resin film | | | | | | | | | |
| Compar- | Lactone | 20 | 12 | Tg + 24 | 2.65 | +0.18 | 4.0 | 0.045 | — | <10 |
| ative | ring-containing | | | | | | | | | |
| Exam- | acrylic-based | | | | | | | | | |
| ple 4 | resin film | | | | | | | | | |
| Compar- | Polyethylene | 20 | 5 | Tg + 25 | 1.0 | +0.88 | 3.0 | 0.29 | — | <10 |
| ative | terephthalate- | | | | | | | | | |
| Exam- | based resin | | | | | | | | | |
| ple 5 | | | | | | | | | | |
| Compar- | Polyolefin- | 25 | 5 | Tg + 40 | 2.0 | −0.12 | 3.0 | 0.04 | — | <10 |
| ative | based resin | | | | | | | | | |
| Exam- | | | | | | | | | | |
| ple 6 | | | | | | | | | | |

As is evident from the above Table, as for an acrylic-based resin irrespective of whether it has a glutarimide ring or a lactone ring, for example, in the case where the polarizing film has a thickness of 10 μm or less, e.g., 5 μm, and the protective film has a thickness of 40 μm or less, e.g., 40 μm or 20 μm, and a dimensional change rate of 0.2% or more, no crack formation occurs even when a given heat cycle is applied to the optical film laminate, and the number of heat cycles taking place before a crack having a given depth is formed in the optical film laminate is 70 or more, i.e., a good result can be obtained. Further, when a good result is obtained in terms of the crack formation and the heat cycle, the ratio of the dimensional change rate of the transparent protective film to the dimensional change rate of the polarizing film is 0.07 or more (in case of taking into account error, 0.05 or more).

In the above Examples, only Example 6 is shown as Example concerning a lactone ring. However, considering that the Tg (126° C.) of the lactone ring is approximately equal to the Tg (127° C.) of the glutarimide ring, they can be deemed to be substantially the same ring, from a viewpoint of the dimensional change rate, i.e., from a viewpoint of the molecular-orientation property. Thus, even though there is no Example, a lactone ring-containing acrylic-based resin can be basically considered as an equivalent of a glutarimide ring-containing acrylic-based resin. Further, it is apparent to a person of ordinary skill in the art that an acrylic-based resin having a glutaric anhydride structure introduced therein, or an acrylic-based resin copolymerized with N-substituted maleimide such as phenylmaleimide, cyclohexylmaleimide or methylmaleimide, can obtain the same result.

On the other hand, as for a polyethylene terephthalate-based resin, for example, in the case where the polarizing film and the protective film have, respectively, a thickness of 10 μm or less, e.g., 5 μm, and a thickness of 40 μm or less, e.g., 20 μm, and a stretching ratio of the protective film is set to 2.0 (or more), the number of heat cycles taking place before a crack having a given depth is formed in the optical film laminate is 80 or more, i.e., a good result can be obtained. Further, when a good result is obtained in terms of the heat cycle, the ratio of the dimensional change rate of the transparent protective film to the dimensional change rate of the polarizing film is 0.59 or more.

Although the above Examples show PET as an example of the polyethylene terephthalate-based resin, it is apparent to a person of ordinary skill in the art that a polyethylene terephthalate-based resin other than PET, such as polybutylene terephthalate, polyethylene naphthalate or polybutylene naphthalate, can obtain the same result.

Further, as for a polyolefin-based resin, for example, in the case where the polarizing film and the protective film have, respectively, a thickness of 10 μm or less, e.g., 5 μm, and a thickness of 40 μm or less, e.g., 25 am, and the stretching temperature of the protective film is set to Tg+30° C. (or less), the number of heat cycles taking place before a crack having a given depth is formed in the optical film laminate is 70 or more, i.e., a good result can be obtained. Further, when a good result is obtained in terms of the heat cycle, the ratio of the dimensional change rate of the transparent protective film to the dimensional change rate of the polarizing film is 0.08 or more.

### 6. Device Configuration

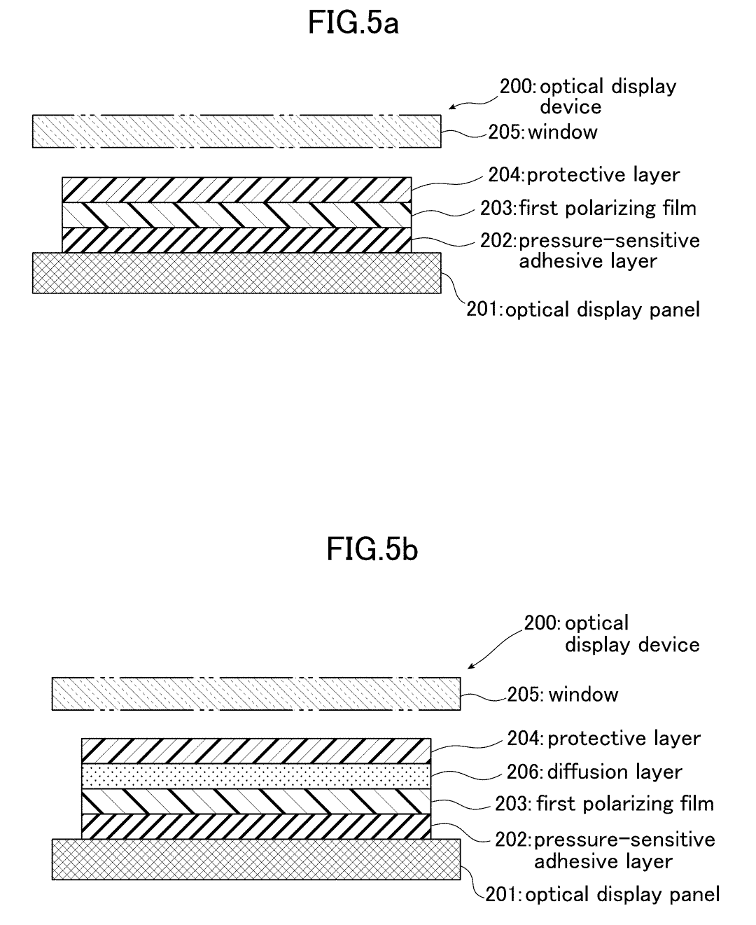

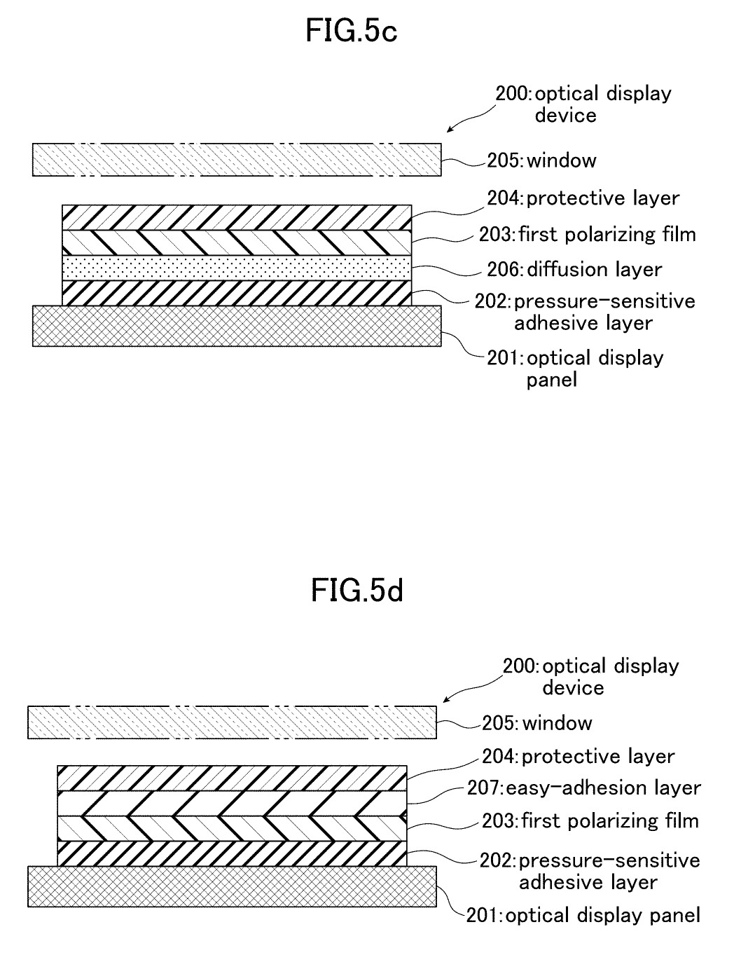

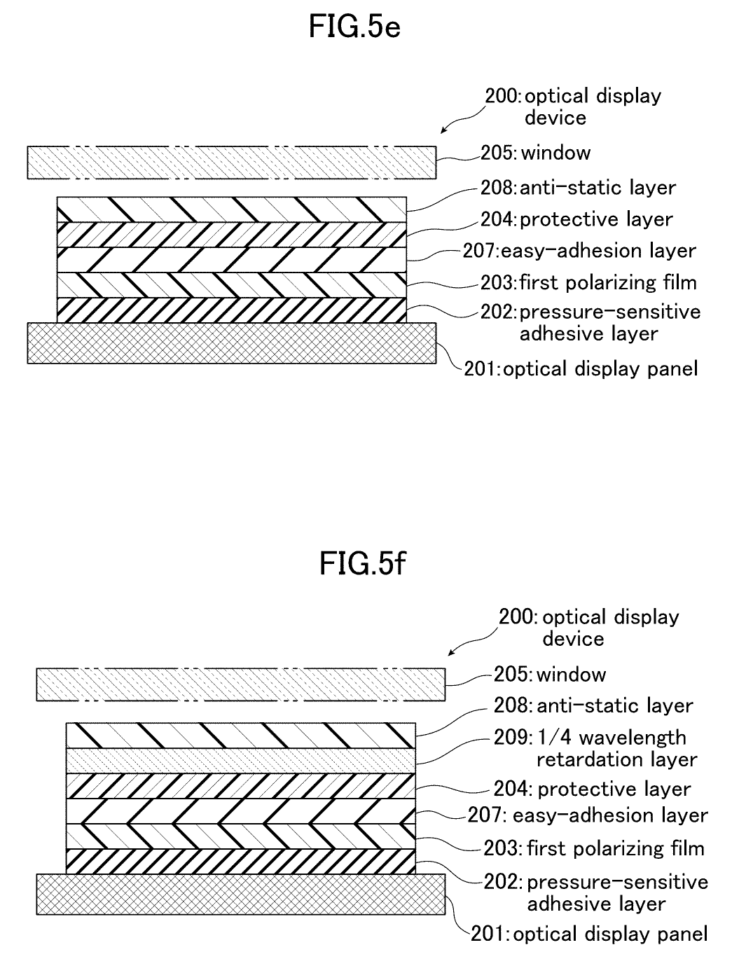

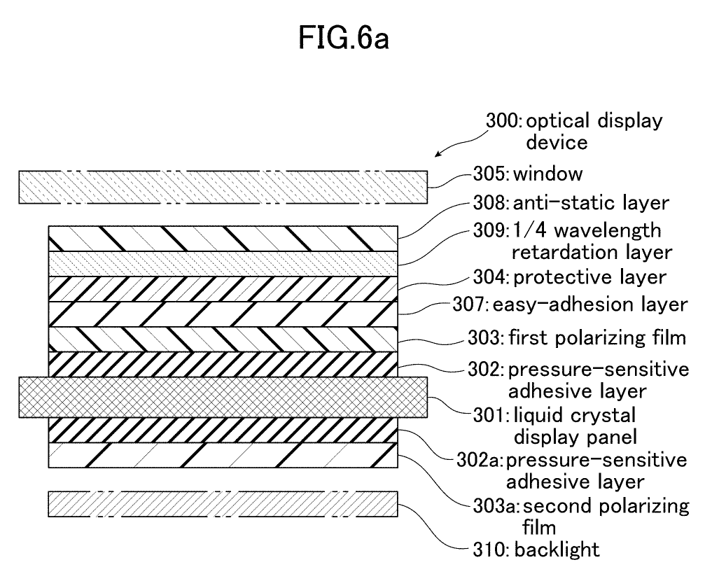

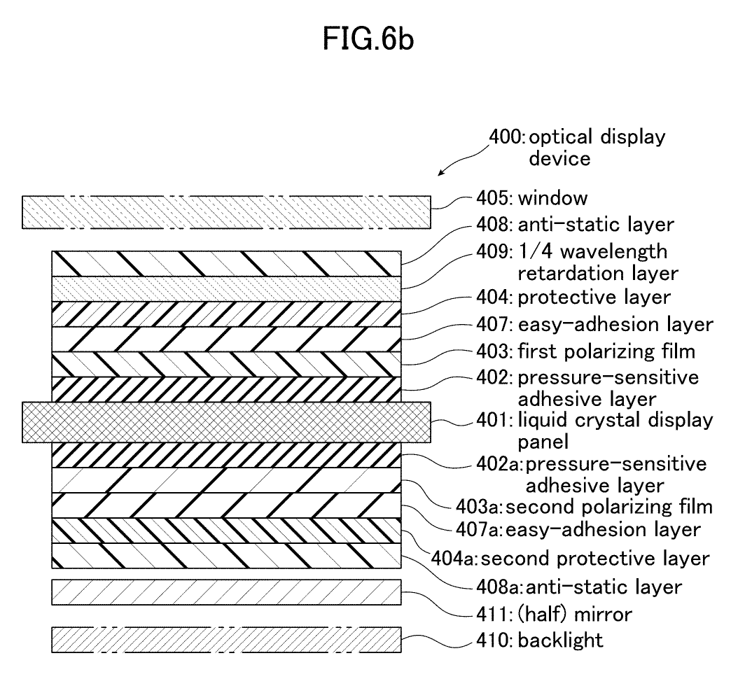

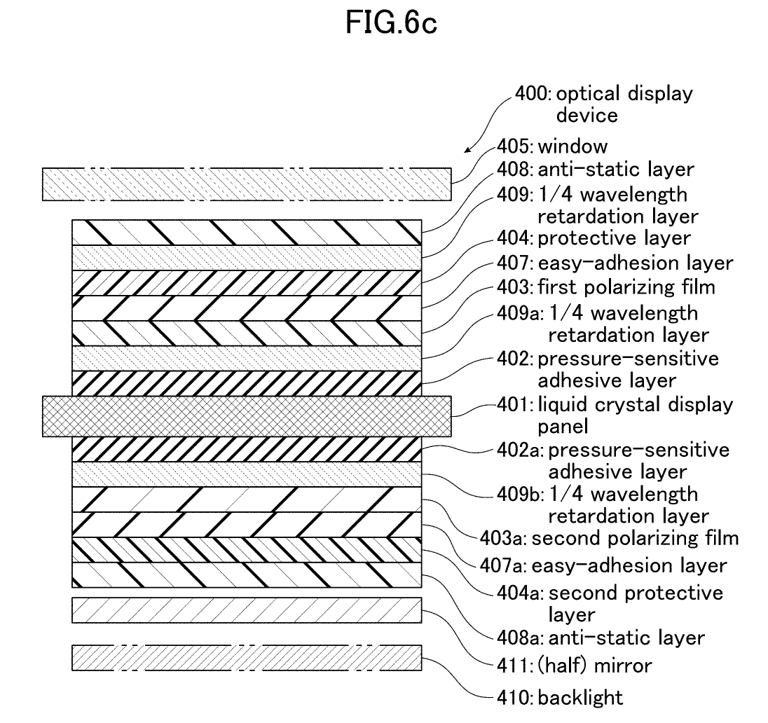

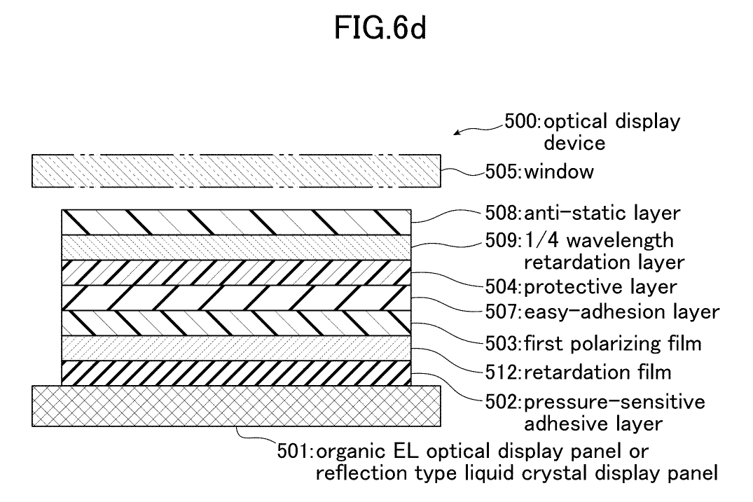

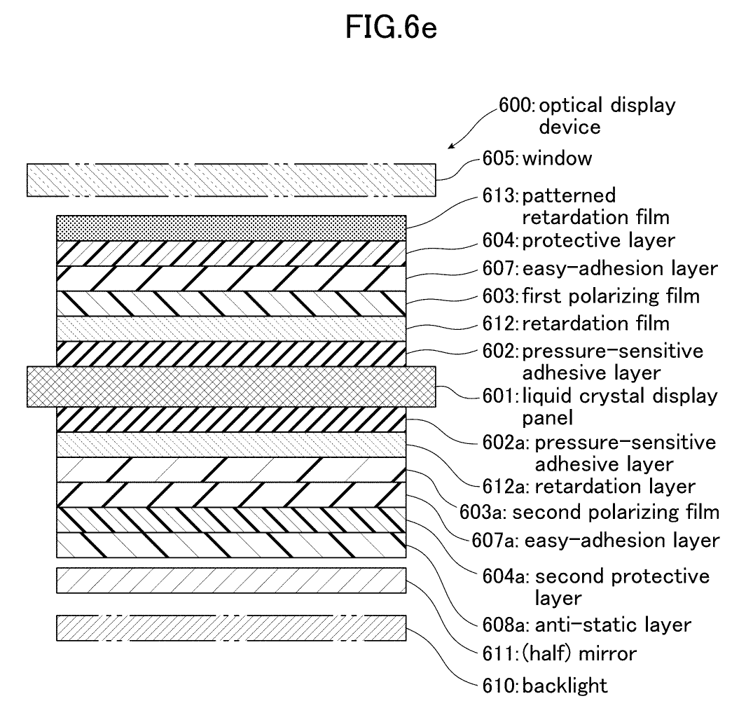

FIGS. 5 and 6 depict (layer configurations of) optical display devices according to various embodiments of the present invention, using an optical film laminate according to the present invention.

FIG. 5a is a sectional view depicting a most basic configuration of an optical display device using an optical film laminate according to the present invention. This optical display device 200 comprises: an optical display panel 201 which may be a liquid crystal panel or an organic EL display panel; and a polarizing film 203 bonded to one surface of the display panel 201 through an optically-transparent pressure-sensitive adhesive layer 202. Further, a protective film (hereinafter referred to as “protective layer”) 204 formed of an optically-transparent resin material is bonded to the other, outer, surface of the polarizing film 203 through an adhesive layer (not depicted). Optionally, a transparent window 205 may be disposed outside the protective layer 204, i.e., on a viewing side of the optical display device, as indicated by the broken line.

As a material for joining or bonding layers or films together, it is possible to appropriately selectively use, as a base polymer, at least one selected from the group consisting of acrylic-based polymer, silicone-based polymer, polyester, polyurethane, polyamide, polyether, fluorine or rubber-based polymer, isocyanate-based polymer, polyvinyl alcohol-based polymer, gelatin-based polymer, vinyl or latex-based polymer, and waterborne polyester.

In this configuration, the pressure-sensitive adhesive layer 202 may be formed of a material having a diffusing function, or may be composed of a two-layer structure of a pressure-sensitive adhesive layer and a diffusing material layer.

As a material for improving an adhesive force of the pressure-sensitive adhesive layer 202, an anchor layer (not depicted) as described, for example, in JP 2002-258269A, JP 2004-078143A or JP 2007-171892A may be provided. As a binder resin is not particularly limited as long as it is capable of improving an anchoring force of a pressure-sensitive adhesive, and specific examples thereof may include an epoxy-based resin, an isocyanate-based resin, a polyurethane-based resin, a polyester-based resin, polymers having an amino group in the molecule, an ester urethane-based resin, or a resin (polymer) having an organic reactive group such as any of various acrylic resins containing an oxazoline group or the like.

Further, with a view to imparting an anti-static property, an anti-static agent as described, for example, in JP 2004-338379A may be added to the anchor layer. Examples of the anti-static agent for imparting an anti-static property includes: an ionic surfactant-based material; a conductive polymer-based material such as polyaniline, polythiophene, polypyrrole or polyquinoxaline; and a metal oxide-based material such as tin oxide, antimony oxide or indium oxide. Particularly, from a viewpoint of optical properties, appearance, anti-static effect and stability of anti-static effects during heating or humidification, it is preferable to use the conductive polymer-based material. Among the conductive polymer-based materials, it is particularly preferable to use a water-soluble conductive polymer such as polyaniline or polythiophene, or a water-dispersible conductive polymer. When the water-soluble conductive polymer or the water-dispersible conductive polymer is used as a material for forming an anti-static layer, it becomes possible to suppress transformation of an optical film substrate due to an organic solvent during coating.

A surface of the protective layer 204 on which the polarizing film 203 is not bonded may be provided with a hard coat layer as a surface-treated layer, or may be subjected to antireflection treatment or treatment for the purpose of anti-sticking, diffusion or anti-glare. The surface-treated layer may contain ultraviolet absorbing agent. Further, the surface-treated layer is preferably a layer having a low moisture permeability for the purpose of improving humidification durability of the polarizing film. A hard coat treatment is performed for the purpose of anti-scratching of a surface of the polarizing film or the like. The hard coat layer can be formed, for example, by a method comprising adding, to the surface of the transparent protective film, a cured coating film having excellent hardness, a sliding property and others based on an appropriate UV-curable resin such as an acrylic-based UV-curable resin or a silicone-based UV-curable resin. The anti-reflection treatment is performed for the purpose of preventing reflection of outside light on the surface of the polarizing film, and can be achieved by formation of a low-reflective layer of a type based on a conventional technique, such as a thin-layer type capable of preventing reflection by means of a reflected light-canceling effect arising from an optical interference action, as disclosed, for example in JP 2005-248173A, or a structure type capable of providing a fine structure to the surface to thereby develop a low reflectance, as disclosed, for example, in JP 2011-2759A. The anti-sticking treatment is performed for the purpose of preventing adhesion with an adjacent layer (e.g., a diffusion plate on a backlight side). The anti-glare treatment is performed for the purpose of preventing viewing of light transmitted through the polarizing film from being hindered due to outside light reflected by the surface of the polarizing film, or the like, and can be achieved, for example, by providing a fine uneven structure to the surface of the protective film based on an appropriate method, such as a surface-roughening technique based on sandblasting or embossing or a technique of adding transparent fine particles. An anti-glare layer may also serve as a diffusion layer (e.g., a viewing angle-broadening function) for diffusing light transmitted through the polarizing film to broaden a viewing angle or the like. The hard coat layer preferably has a hardness equivalent to a pencil hardness of 2H or more.

A configuration of an optical display device depicted in FIG. 5(b) is approximately the same as that depicted in FIG. 5(a), except that a diffusion layer 206 is disposed between the polarizing film 203 and the protective layer 206. In a configuration depicted in FIG. 5(c), the diffusion layer 206 is disposed between the pressure-sensitive adhesive layer 202 and the polarizing film 203. An optical display device depicted in FIG. 5(d) is approximately the same as that depicted in FIG. 5(a), except that the polarizing film 203 is bonded to the protective layer 204 through an easy-adhesion layer 207 for facilitating bonding. As the easy-adhesion layer 207, it is possible to use a material disclosed, for example, in JP 2010-55062A.

An optical display device depicted in FIG. 5(e) is different from the optical display device depicted in FIG. 5(d), only in that an anti-static layer 208 is provided on an outer surface of the protective later 204. An optical display device 200 depicted in FIG. 5(f) is obtained by modifying the configuration of the optical display device depicted in FIG. 5(e) such that a ¼ wavelength retardation film 209 is disposed between the protective later 204 and the anti-static layer 208. Alternatively, the ¼ wavelength retardation film may be disposed on the viewing side with respect to the anti-static layer. In this case, the ¼ wavelength retardation film is disposed on the viewing side with respect to the polarizing film 203, so that light coming from the display panel 201 through the polarizing film 203 is converted to a circularly-polarized light when it exits from the ¼ wavelength retardation film. The optical display device having this configuration provides an advantage of being able to prevent hindering of viewing, for example, even when a viewer wears a polarized sunglass.

FIG. 6(a) depicts an optical display device 300 comprising a transmission type liquid crystal display panel 301 as an optical display panel, according to another embodiment of the present invention. A configuration on the viewing side with respect to the liquid crystal display panel 301 is approximately the same as the configuration of the optical display device 200 depicted in FIG. 5(f). Specifically, a first polarizing film 303 is bonded to a viewing-side surface of the liquid crystal display panel 301 through a pressure sensitive adhesive layer 302, and a protective layer 304 is bonded to the first polarizing film 303 through an easy-adhesive layer 307. A ¼ wavelength retardation layer 309 is bonded to the protective layer 304. Optionally, an anti-static layer 308 is formed on the ¼ wavelength retardation layer 309. Further, a window 305 is optionally disposed outside the ¼ wavelength retardation layer 309. In the embodiment depicted in FIG. 6(a), a second polarizing film 303a is disposed on the other surface of the liquid crystal display panel 301 through a second pressure-sensitive adhesive layer 302a. As is well known in the field of transmission type liquid crystal display devices, a backlight 310 is disposed on a back side of the second polarizing film 303a.

FIG. 6(b) depicts an optical display device 400 comprising a reflection type liquid crystal display panel 401 as an optical display panel, according to another embodiment of the present invention. A configuration on the viewing side with respect to the liquid crystal display panel 401 is approximately the same as the configuration of the optical display device 300 depicted in FIG. 6(a). Specifically, a first polarizing film 403 is bonded to a viewing-side surface of the liquid crystal display panel 401 through a pressure sensitive adhesive layer 402, and a protective layer 404 is bonded to the first polarizing film 403 through an easy-adhesive layer 407. A ¼ wavelength retardation layer 409 is bonded to the protective layer 404. Optionally, an anti-static layer 408 is formed on the ¼ wavelength retardation film 409. Further, a window 405 is optionally disposed outside the ¼ wavelength retardation layer 409.

In the embodiment depicted in FIG. 6(b), a second polarizing film 403a is disposed on the other surface of the liquid crystal display panel 401 through a second pressure-sensitive adhesive layer 402a, and a second protective layer 404a is bonded to the second polarizing film 403a through an easy-adhesive layer 407a. Optionally, an anti-static layer 408a is formed on the second protective layer 404a. A mirror 411 for reflecting light transmitted through the liquid crystal display panel 401, toward the liquid crystal display panel 401 is disposed on a back side of the second protective layer 404a. In this configuration, outside light entering from the viewing side is reflected by the mirror 411 and transmitted through the liquid crystal display panel 401, whereafter it exits from the optical display device 400 to the outside, so that a user can view a display from the viewing side.

In this configuration, the mirror 411 may be composed of a half mirror capable of transmitting a part of incident light therethrough. In the case where the mirror 411 is composed of a half mirror, a backlight 410 is disposed on a back side of the mirror 411, as indicated by the two-dot chain line. In this configuration, when it is dark outside, display can be performed by turning on the backlight 410.

FIG. 6(c) depicts another embodiment. This embodiment is different from the embodiment depicted in FIG. 6(b), in that a ¼ wavelength retardation layer 409a is disposed between the first polarizing film 403 and the liquid crystal panel 401, and a ¼ wavelength retardation layer 409b is disposed between the second polarizing film 403a and the liquid crystal panel 401. More specifically, the ¼ wavelength retardation layer 409a is bonded to the first polarizing film 403, and bonded to the viewing-side surface of the liquid crystal panel 401 through the pressure-sensitive adhesive layer 402. Similarly, the ¼ wavelength retardation layer 409b is bonded to the second polarizing film 403a, and bonded to a back-side surface of the liquid crystal panel 401 through the pressure-sensitive adhesive layer 402a.

In this configuration, the ¼ wavelength retardation layer 409a and the ¼ wavelength retardation layer 409b have a function of improving display brightness of the display device as described in Y. Iwamoto, et al., “Improvement of Transmitted Light Efficiency in SH-LCDs Using Quarter-Wave Retardation Films”, SID Digest of Tech. Papers, 2000, pp. 902 to 905.

In each of the above embodiments, each of the protective layer mat be formed of the aforementioned materials.

FIG. 6(d) depicts an optical display device 500 using an optical display panel 501 composed of an organic EL display panel or a reflection type liquid crystal display panel. A retardation film 512 is bonded to a viewing-side surface of the liquid crystal display panel 501 through a pressure sensitive adhesive layer 502, and a polarizing film 503 is bonded to the retardation film 512. The polarizing film 503 is bonded to a protective layer 504 through an easy-adhesion layer 507, and a ¼ wavelength retardation layer 509 is bonded to the protective layer 504. Optionally, an anti-static layer 508 may be formed on the ¼ wavelength retardation layer 509. Further, a window 505 may be optionally disposed outside the ¼ wavelength retardation layer 509. The retardation film 512 is used to prevent light input from the viewing side of the polarizing film 503 from being output toward the viewing side due to internal reflection.

The retardation film 512 disposed between the polarizing film 503 and the display panel 501 may be composed of a ¼ wavelength retardation film. In this case, the retardation film 512 may be composed of a biaxial retardation film satisfying the following relationship: nx>nz>ny, where: nx denotes a refractive index in a slow axis direction; nz denotes a refractive index in an in-plane direction orthogonal to the slow axis direction; and ny denotes a refractive index in a thickness direction. In this configuration, the retardation film 512 is disposed such that the slow axis direction is at 45 degrees with respect to an absorption axis of the polarizing film 503. In this case, it become possible to further obtain an anti-reflection effect in an oblique direction. Although not depicted, a mirror is generally disposed on a back side of the display panel 501.

FIG. 6(e) depicts an optical display device 600 according to another embodiment of the present invention. In this embodiment, the optical display panel is composed of a transmission type IPS liquid crystal display panel 601, wherein a retardation film 612 is bonded to a viewing-side surface of the liquid crystal display panel 601 through a pressure sensitive adhesive layer 602, and a polarizing film 603 is bonded to the retardation film 612. The polarizing film 603 is bonded to a protective layer 604 through an easy-adhesion layer 607, and a patterned retardation layer 613 is bonded to the protective layer 604. This patterned retardation layer 613 forms a patterned retardation film as described in Kenji MATSUHIRO, “Xpol and Application thereof to 3D-TV”, EKISHO, Vol. 14, No. 4, 2010, PP. 219 to 232. The patterned retardation later has a function of changing a right eye's image and a left eye's image output from display panel, respectively, to different polarization states so as to enable 3D display. Optionally, a window 605 may be disposed outside the patterned retardation layer 613. The IPS mode includes a super in-plain switching (S-IPS) mode, and an advanced super in-plain switching (AS-IPS) mode, employing a V-shaped electrode, a zigzag-shaped electrode or the like.

A retardation film 612a is bonded to a back-side surface of the liquid crystal panel 601 through a second pressure-sensitive later 602a, and a second polarizing film 603a is bonded to the retardation film 612a. The second polarizing film 603 is bonded to a second protective layer 604 through an easy-adhesion layer 607. Optionally, an anti-static layer 608a is formed on the second protective layer 604a. In the case where the liquid crystal display panel 601 is a reflection type liquid crystal panel, a mirror 611 for reflecting light transmitted through the liquid crystal display panel 601, toward the liquid crystal display panel 601, is disposed on a back side of the second protective layer 604a. When the mirror 611 is composed of a half mirror, a backlight 610 is disposed on a back side of the mirror 611. On the other hand, in the case where the liquid crystal display panel 601 is a transmission type, the mirror 611 is omitted, and only a backlight 610 is disposed.

In this configuration, each of the retardation films 621, 621a may be composed of a biaxial retardation film satisfying the following relationship: nx>nz>ny, where: nx denotes a refractive index in a slow axis direction; nz denotes a refractive index in an in-plane direction orthogonal to the slow axis direction; and ny denotes a refractive index in a thickness direction. Alternatively, the retardation film 621a may be formed in a two-layer structure of a biaxial retardation film satisfying the following relationship: nx>nz>ny, and a biaxial retardation film satisfying the following relationship: nx>ny>nz. In the above configurations, the retardation film is disposed such that the slow axis direction is at 0 degree or 90 degrees with respect to an absorption axis of the polarizing film. This arrangement is effective in correction of an intersecting angle with respect to the polarizing film, when viewed from am oblique direction.

The panel configuration in FIG. 6(e) can also be used in a situation where the liquid crystal display panel 610 is a transmission type VA liquid crystal display panel.

In this case, each of the retardation films 621, 621a may be composed of a biaxial retardation film satisfying the following relationship: nx>nz>ny, or a biaxial retardation film satisfying the following relationship: nx>ny>nz. Alternatively, each of the retardation films 621, 621a may be composed of a retardation film satisfying the following relationship: nx>ny−nz, or a retardation film satisfying the following relationship: nx−ny>nz. In either case, the retardation film is disposed such that the slow axis direction is at 0 degree or 90 degrees with respect to the absorption axis of the polarizing film. This arrangement is effective in not only correction of an intersecting angle with respect to the polarizing film, when viewed from am oblique direction, but also compensation of retardation of liquid crystal in the thickness direction.

### INDUSTRIAL APPLICABILITY

The optical film laminate according to the present invention is widely usable for optical display devices such as a television, a mobile phone and a personal digital assistant.

### LIST OF REFERENCE SIGNS

3: polarizing film
4: protective film
13: optical film laminate

1. An optical film laminate comprises: a polarizing film formed of a polyvinyl alcohol-based resin containing a molecularly-oriented dichroic martial, the polarizing film having a thickness of 10 μm or less; and a transparent protective film formed of a thermoplastic resin and disposed on one of opposite surfaces of the polarizing film through an adhesive layer, wherein
the transparent protective film has a thickness of 40 μm or less, and a dimensional change rate in a direction orthogonal to an absorption axis of the polarizing film is 0.2% or more, as measured using a test piece thereof having a size of 100 mm×100 mm, in a state after leaving the test piece in an environment at 85° C. for 48 hours.

2. The optical film laminate as recited in claim 1, wherein, in the direction orthogonal to the absorption axis of the polarizing film, a ratio of the dimensional change rate of the transparent protective film to a dimensional change rate of the polarizing film is from 0.05 to 1.

3. The optical film laminate as recited in claim 1, wherein an easy-adhesion layer is provided between the adhesive layer and the polarizing film.

4. The optical film laminate as recited in claim 1 wherein the transparent protective film is one selected from the group consisting of an acrylic-based resin film, a polyethylene terephthalate-based resin layer, and a polyolefin-based resin film.

5. The optical film laminate as recited in claim 1 wherein the transparent protective film is an acrylic-based resin film which is stretched in a direction orthogonal to the absorption axis of the polarizing film, at a temperature equal to or greater than a glass transition temperature of the acrylic-based resin film.

6. The optical film laminate as recited in claim 5, wherein the transparent protective film is formed using an acrylic-based resin film which has a glutarimide ring or a lactone ring in a main chain thereof.

7. An optical display device using the optical film laminate as recited in claim 1.

8. A transparent protective film formed of a thermoplastic resin, wherein the transparent protective film has a thickness of 40 μm or less, and a dimensional change rate in a direction orthogonal to an absorption axis of a polarizing film is 0.2% or more, as measured using a test piece thereof having a size of 100 mm×100 mm, in a state after leaving the test piece in an environment at 85° C. for 48 hours.

9. The transparent protective film as recited in claim 8, which is disposed, through an adhesive layer, on one of opposite surfaces of a polarizing film which is formed of a polyvinyl alcohol-based resin containing a molecularly-oriented dichroic martial, and has a thickness of 10 μm or less.

10. The transparent protective film as recited in claim 8, which is one selected from the group consisting of an acrylic-based resin film, a polyethylene terephthalate-based resin layer, and a polyolefin-based resin film.

11. The transparent protective film as recited in claim 8 which is an acrylic-based resin film stretched in a direction orthogonal to the absorption axis of the polarizing film, at a temperature equal to or greater than a glass transition temperature of the acrylic-based resin film.

12. The transparent protective film as recited in claim 11, which is formed using an acrylic-based resin film having a glutarimide ring or a lactone ring in a main chain thereof.
